(19) United States
(12) Patent Application Publication
(10) Pub. No.: US 2012/0275274 A1
(43) Pub. Date: Nov. 1, 2012

(54) ACOUSTIC TRANSPONDER FOR MONITORING SUBSEA MEASUREMENTS FROM AN OFFSHORE WELL

(75) Inventors: Matthew Gochnour, Houston, TX (US); Graham Openshaw, Portsmouth, NH (US); Jonathan Peter Davis, Cypress, TX (US)

(73) Assignee: BP CORPORATION NORTH AMERICA INC., Houston, TX (US)

(21) Appl. No.: 13/452,263

(22) Filed: Apr. 20, 2012

Related U.S. Application Data
(60) Provisional application No. 61/479,260, filed on Apr. 26, 2011.

(51) Int. Cl. G10K 11/18; H04B 11/00

(52) U.S. Cl. 367/134; 367/141

(57) ABSTRACT

Sensor and communications systems for communicating measurements from subsea equipment, such as at an offshore well, to the surface. A sensor for a physical parameter, such as pressure or temperature at a blowout preventer, capping stack, or conduit in communication with the same, is electrically connected to a subsea acoustic transponder. An acoustic monitoring transponder deployed near the well periodically interrogates the acoustic transponder with an acoustic signal, in response to which the acoustic transponder transmits an acoustic signal encoded with the measurement. The measurement data are stored at the acoustic monitoring transponder. An acoustic communications device later interrogates the acoustic monitoring transponder to receive the stored measurement data for communication to a redundant network at the surface.

### CROSS-REFERENCE TO RELATED APPLICATIONS

This application claims the benefit of U.S. Provisional Application No. 61/479,260 filed Apr. 26, 2011.

This application is related to copending and commonly assigned Attorney Docket Number 41000 entitled “Acoustic Telemetry of Subsea Measurements from an Offshore Well”, filed contemporaneously herewith and incorporated herein by reference.

### STATEMENT REGARDING FEDERALLY SPONSORED RESEARCH OR DEVELOPMENT

Not applicable.

### BACKGROUND

This invention is in the field of oil and gas production. Embodiments of this invention are directed to the monitoring and communication of measurements, such as pressures, from deep subsea equipment, such as blowout preventers and capping stacks installed at offshore oil and gas wells.

As known in the art, the penetration of high-pressure reservoirs and formations during the drilling of an oil and gas well can cause a sudden pressure increase (“kick”) in the wellbore itself. A significantly large pressure kick can result in a “blowout” of drill pipe, casing, drilling mud, and hydrocarbons from the wellbore.

Blowout preventers (“BOPs”) are commonly used in the drilling and completion of oil and gas wells to protect drilling and operational personnel, and the well site and its equipment, from the effects of a blowout. In a general sense, a blowout preventer is a remotely controlled valve or set of valves that can close off the wellbore in the event of an unanticipated increase in well pressure. Modern blowout preventers typically include several valves, or “rams”, arranged in a “stack” surrounding the drill string. The valves within a given stack typically differ from one another in their manner of operation, and in their pressure rating, thus providing varying degrees of well control, including sealing of the well annulus at various pressures. Many BOPs include a valve of a “blind shear ram” type, which can sever the drill string and seal the wellbore, serving as potential protection against a blowout. As known in the art, the individual valves in blowout preventers are hydraulically actuated in response to initiation by electrical signals; other techniques for activating the blowout preventer include an “Autoshear” approach in which the valves are activated automatically in the event of an unplanned LMRP disconnect, and a “deadman” automatic mode in which the valves are activated in the event that the control systems lose their communication, electrical power, and hydraulic functions. In addition, some blowout preventers can be actuated by remote operated vehicles (ROVs), should the internal electrical and hydraulic control systems become inoperable. Typically, some level of redundancy for the control systems in blowout preventers is provided.

To carry out monitoring and analysis, measurements are obtained from the blowout preventer during periodic testing, and also by monitoring certain parameters during drilling and well completion. In deep sub-sea environments, sensors for measuring downhole pressure and other parameters are conventionally deployed in the “Christmas tree” at the seafloor, and in the blowout preventer. In addition, during the drilling operation, measurements regarding the drilling operation can be acquired (measurement-while-drilling, or “MWD”) downhole, as can measurements regarding the surrounding formation into which the drilling is being performed (logging-while-drilling, or “LWD”). During production, sensors in the production tubing at the seafloor or below are often deployed to make electrical measurements from which corrosion monitoring can be carried out.

These and other measurements must be communicated in some manner to the surface, for analysis by the appropriate systems and personnel. Various conventional communication techniques utilize the drill pipe or production tubing as the communications medium. For example, wired drill pipe and production tubing is now commonplace, with signals transmitted from the seafloor or even downhole along wire or optical fibers running the length of the drill pipe or tubing to the surface. These wired or fiber optic communications approaches are available for communication of pressure measurements from the blowout preventer. Other telemetry approaches useful in the drilling context include mud pulse telemetry within the drill string, and electromagnetic telemetry (EM tools).

In each of these cases, however, communication of pressure measurements from the seafloor or below utilize an intact physical communications conduit between the subsurface sensors and surface vessels, in the offshore production context. Unfortunately, given the environment often encountered in offshore production, as well as the long distances between surface and seafloor in modern deep offshore production, the communication conduit can become corrupted, compromised, or discontinuous. For example, the wire or optical fibers in “wired” production tubing can corrode, break, or otherwise lose good transmission capability.

In some cases, the drill string or production tubing may itself become broken or cut, for example in the case of a blowout of the well and subsequent severing of the riser from the blowout preventer, thus severing the communications facility between the seafloor and the surface. In these events, the monitoring of pressures at the blowout preventer, or at a subsequently deployed capping stack placed over the blown-out well, becomes beneficial in managing the failed well. These pressure measurements may provide an indication of the ability of the blowout preventer or capping stack to control the well, and also indicate whether the well casing and rupture disks are intact and maintaining integrity. In addition, pressure measurements at production equipment, such as the choke and kill lines at the blowout preventer, allow monitoring of remediation efforts involved in shutting-in the well after the blowout preventer rams have been activated.

By way of further background, the use of remote operated vehicles (ROVs) is now commonplace in offshore drilling and production. Navigation of an undersea ROV requires knowledge of its position relative to the subsea installations. As known in the art, the dynamic positioning of ROVs can be accomplished by acoustic signaling between the ROV and multiple fixed transponders. The fixed transponders, for example computerized acoustic telemetry transponders (“Compatts”) such as those available from Sonardyne, Inc., include acoustic transceivers for communication with ROVs and surface vessels. According to one conventional positioning approach, the ROV issues an acoustic interrogation signal to a transponder (e.g., a Compatt) deployed at a known location, in response to which the transponder issues an acoustic signal. The response signal may be a simple tone at a frequency particular to the specific transponder, or may be a modulated wideband signal (such as a phase-shift keyed, or PSK, modulated signal) such as the wideband technology used by the Sonardyne Compatts. In one approach, for example as used by the Sonardyne Compatts, the modulated response signal from the transponder includes information indicating the location of the transponder as deployed. Based on the location information and the travel time of the response signal (e.g., the round-trip travel time of the interrogation signal plus the response) from multiple fixed-location transponders, the location of the ROV can be calculated using triangulation or trilateralization (in which the location information of the transponder is used in combination with the signal travel time).

By way of further background, modern transponders, such as the COMPATT5 and COMPATT6 acoustic transponders from Sonardyne, Inc., are capable of carrying out data telemetry. These transponders can be deployed with optional sensors, such as inclinometers, pressure sensors, and strain gauges, and include a modem function to acoustically communicate measurement data acquired from those sensors. By way of still further background, the COMPATT6 acoustic transponder can operate in a data logging mode, by way of which measurements from its end cap sensors obtained over time can be stored within the transponder.

Copending and commonly assigned application Attorney Docket No. 41000, entitled “Acoustic Telemetry of Subsea Measurements from an Offshore Well”, filed contemporaneously herewith and incorporated herein by reference, discloses a system and method of obtaining measurement data from sensors at subsea equipment, such as a blowout preventer and a capping stack, and acoustically communicating that measurement data from an acoustic transponder connected to the sensors to an ROV or transponder supported from a surface ship, for communication of that measurement data to a surface network. As is known in the industry, however, inclement surface conditions at sea and other factors can preclude the deployment of surface ships in the vicinity of the well, which breaks the communications links between the subsea sensors and the personnel monitoring and managing the well in the manner described in that copending application. But the need for relatively continuous and real-time measurements of conditions at the well may well continue, despite the inclement surface conditions.

### BRIEF SUMMARY

Embodiments of this invention provide a communications system and method of operating the same by way of which pressure measurements and the like at subsea equipment can be acquired and stored subsea for later acquisition, in situations in which the normal communications facility has been severed, compromised, or otherwise corrupted.

Embodiments of this invention provide a system and method in which subsea measurements can be acquired and stored despite surface conditions preventing the deployment of surface vessels and remotely operated vehicles (ROVs).

Embodiments of this invention provide a system and method that is suitable for use in deep subsea environments.

Embodiments of this invention provide a system and method that can be readily and rapidly deployed into the blowout preventer after its activation and the resulting shearing of the drill string or production tubing, and in advance of approaching weather events such as hurricanes.

Embodiments of this invention provide a system and method that is compatible with various coupling mechanisms at subsea installations.

Embodiments of this invention provide a system and method suitable for use in connection with both blowout preventers and capping stacks.

Other objects and advantages of embodiments of this invention will be apparent to those of ordinary skill in the art having reference to the following specification together with its drawings.

This invention may be implemented into a sensor and acoustic transponder arrangement that can be installed at appropriate locations of a sealing element assembly, such as a blowout preventer or capping stack, after the severing or compromise of the riser and drill string, or production tubing, as the case may be. The sensor is installed by way of a flange, or hot stab, to be in fluid communication with the desired location of the well or subsea equipment, and in electrical communication with an acoustic transponder. One acoustic transponder is electrically connected to the sensor, and is capable of transmitting measurement data upon interrogation. A monitoring acoustic transponder is installed near the first transponder, for example in advance of a hurricane or other surface event that prevents deployment of remotely operated vehicles (ROVs) and the like. This monitoring acoustic transponder is operable to acoustically interrogate the transponder connected to the sensor, on a periodic basis, and to store the measurement data acoustically transmitted in response, within its own memory. Once it is again safe for ships to be in the area, the stored data are acoustically retrieved from the monitoring acoustic transmitter, for example in response to an acoustic interrogation signal issued from an ROV or an acoustic transponder suspended in the vicinity of the acoustic monitoring transponder. The retrieved measurement data are then communicated to surface personnel aboard ship or at an onshore data center.

According to another aspect of the invention, the monitoring transponder may be installed at a subsea location within acoustic range of one or more acoustic transponders coupled with sensors at the subsea equipment, and acquires and stores measurement data over the desired period of time (such as during a storm in the vicinity of the well). Retrieval of the stored data from the monitoring transponder is carried out by physically retrieving the monitoring transponder, for example by way of an ROV, at which time the stored measurement data are directly downloaded over a wired connection into the servers at the surface vessel. This approach eliminates the acoustic polling of the monitoring transponder by an ROV.

### BRIEF DESCRIPTION OF THE SEVERAL VIEWS OF THE DRAWINGS

FIG. 1 is an elevation view illustrating the arrangement of a conventional offshore oil and gas well at the time of drilling.

FIG. 2 is an elevation view of a blowout preventer including its lower marine riser package (LMRP), such as used in the arrangement of FIG. 1.

FIG. 3 is an elevation view illustrating an offshore well after a blowout event, and including measurement and communications systems according to embodiments of the invention.

FIG. 4 is a flow diagram illustrating the generalized operation of embodiments of the invention.

FIGS. 5a through 5e are elevation, perspective, and schematic views of a sensor and transponder arrangement according to an embodiment of the invention.

FIGS. 6a through 6e are elevation, perspective, and schematic views of a sensor and transponder arrangement according to another embodiment of the invention.

FIG. 7a is an elevation view illustrating an offshore well after a blowout event, and including an acoustic monitoring transponder according to embodiments of the invention.

FIG. 7b is a flow diagram illustrating the operation of deployment and data acquisition in the system of FIG. 7a, according to that embodiment of the invention.

FIG. 7c is a flow diagram illustrating the operation of recovering stored measurement data from the acoustic monitoring transponder in the system of FIGS. 7a and 7b, according to that embodiment of the invention.

FIG. 7d is an elevation view illustrating recovery of stored measurement data from an acoustic monitoring transponder according to an alternative embodiment of the invention.

FIG. 7e is a flow diagram illustrating the operation of recovering stored measurement data from the acoustic monitoring transponder in the system of FIG. 7d, according to that embodiment of the invention.

### DETAILED DESCRIPTION

This invention will be described in connection with certain embodiments, specifically as implemented in connection with a blowout preventer, and other subsea equipment such as a capping stack, associated with a deepwater offshore oil well, as it is contemplated that this invention is especially beneficial when implemented in such an application. However, it is contemplated that this invention will be beneficial if applied to other types of equipment in similar environments. Accordingly, it is to be understood that the following description is provided by way of example only, and is not intended to limit the true scope of this invention as claimed.

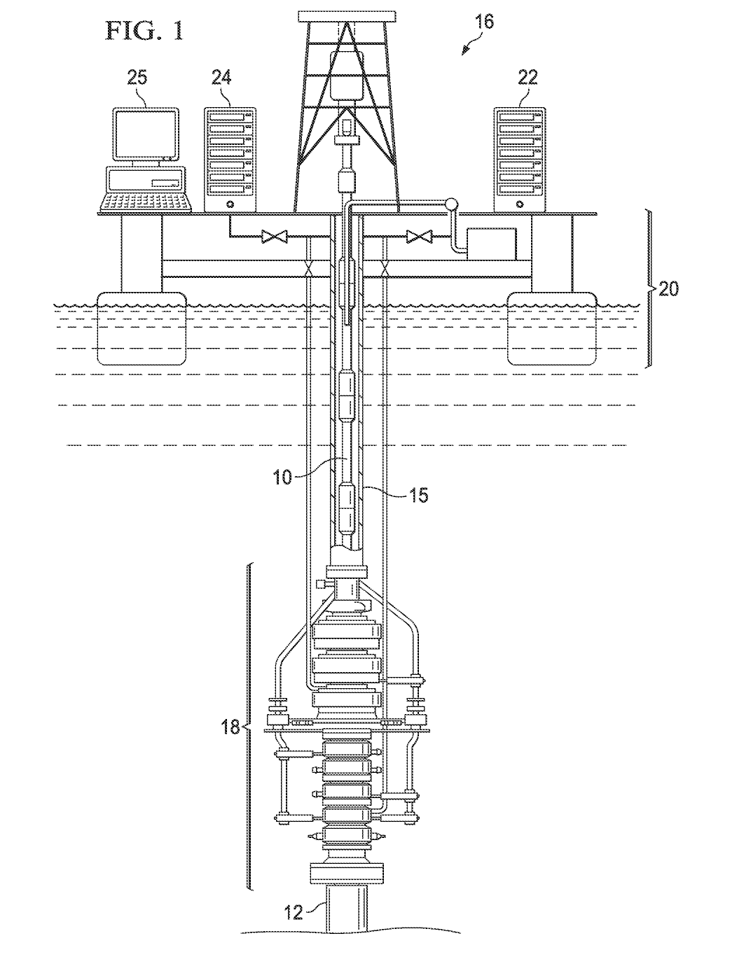

FIG. 1 illustrates a generalized example of the basic conventional components involved in drilling an oil and gas well in an offshore environment, to provide context for this description. In this example, drilling rig 16 is supported at offshore platform 20, and is supporting and driving drill pipe 10 within riser 15, in the conventional manner. Blowout preventer (or BOP) 18 includes the “stack” of sealing rams, and is attached to and supported from wellhead 12, which itself is located at or near the seafloor. Riser 15 is attached to blowout preventer 18 by way of a lower marine riser package, or “LMRP”, which is connected to the bottom of riser 15. Drill pipe 10 passes through riser 15 and blowout preventer 18, and extends into the seafloor to the depth at which drilling is currently taking place.

Modern offshore drilling operations are carried out by way of computer monitoring and control systems. In this regard, drilling control computer 22 is provided at drilling rig 16, to control various drilling functions, including the drilling operation itself and the circulation and control of the drilling mud. Blowout preventer control computer 24 is a computer system that controls the operation of blowout preventer 18. Each of computer resources 22, 24, receives various inputs from downhole sensors along the wellbore, including from sensors deployed within blowout preventer 18. While each of drilling control computer 22 and BOP control computer 24 are deployed at offshore platform 20, in this example, these computer systems are in communication with onshore servers and computing resources by way of radio or satellite communications.

As evident from this description, FIG. 1 illustrates drilling rig 16 in the context of the drilling operations. As fundamental in the art, once drilling of the well to the desired depth is accomplished, various well completion operations will be performed. Upon completing the well, blowout preventer 18 will be removed from wellhead 12 in favor of a control valve tree including production valves and safety control valves. Production from the well will be conducted to subsea manifolds via production tubing, as controlled by the Christmas tree, eventually routing the produced oil and gas to an offshore production facility or subsea flowline, as the case may be.

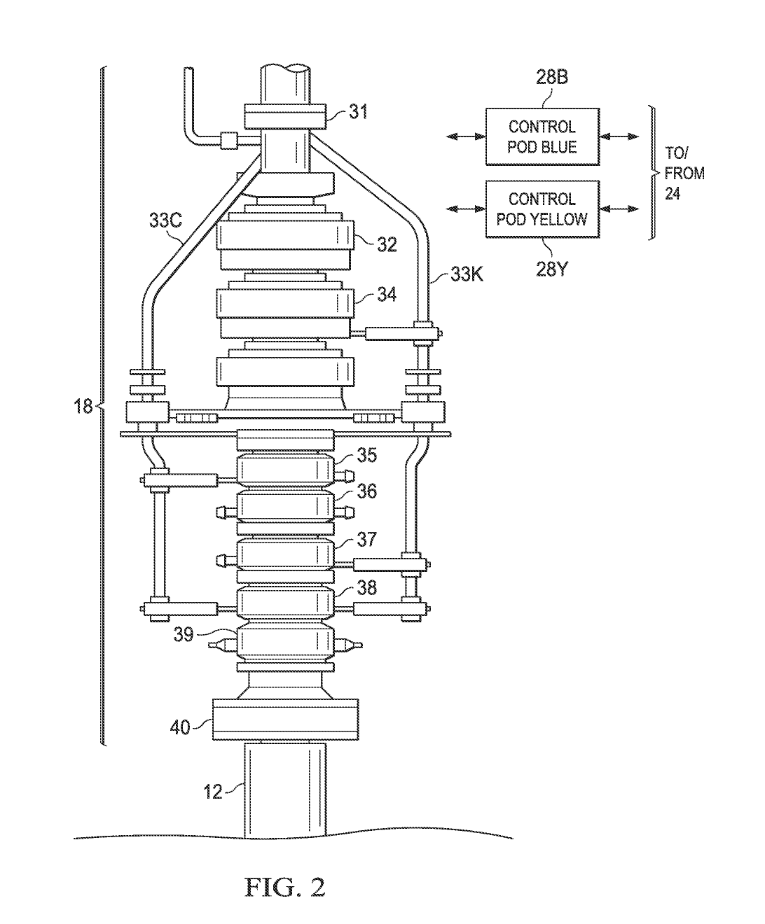

An example of a blowout preventer 18 including its LMRP is shown in greater detail in FIG. 2. Blowout preventer 18 includes multiple types of sealing elements, with the various elements having different pressure ratings, and often performing their sealing function in different ways from one another. Such redundancy in the sealing elements not only supports reliable operation of blowout preventer 18, but also provides responsive well control functionality during non-emergency operations. Of course, the number and types of sealing members within a given blowout preventer will vary from installation to installation, and from environment to environment. As such, the construction of blowout preventer 18 of FIG. 2 is presented in this specification by way of example only, to provide context for the embodiments of the invention described herein.

In this example, as shown in FIG. 2, blowout preventer 18 includes riser connector 31, which connects blowout preventer 18 to riser 15 (FIG. 1); on its opposite end, blowout preventer 18 is connected to wellhead 12 by way of wellhead connector 40. From top to bottom, the sealing elements of this example of blowout preventer 18 include upper annular element 32, lower annular element 34 (the annular elements 32, 34 typically considered as part of the LMRP), blind shear ram element 35, casing shear ram element 36, upper ram element 37, lower ram element 38, and test ram element 39. To summarize, annular elements 34, 35, when actuated, operate as bladder seals against drill pipe 10, and because of their bladder-style construction are useful with drill pipe 10 of varying outside diameter and cross-sectional shape. Ram elements 37, 38, 39 include rubber or rubber-like sealing members of a given shape that press against drill pipe 10 to perform the sealing function. When actuated, shear ram elements 35, 36 operate to shear drill pipe 10 and casing, respectively; blind shear ram element 35 is intended to also seal the wellbore. As mentioned above, these various elements typically have different pressure ratings, and thus provide a wide range of well control functions.

Control pods 28B, 28Y are also shown schematically in FIG. 2. Each of control pods 28B, 28Y include the appropriate electronic and hydraulic control systems, by way of which the various sealing elements are controllably actuated and their positions sensed. Control pods 28B, 28Y are deployed in the lower marine riser package connected to the bottom of riser 15, and provide redundant control channels for operation of the hydraulic control valves involved in the actuation of the various sealing elements as desired. Blue control pod 28B and yellow control pod 28Y are constructed essentially as duplicates of one another, each capable of actuating each of the elements of blowout preventer 18. In addition, BOP control computer 24 includes monitoring and diagnostic capability by way of which the functionality of control pods 28B, 28Y are analyzed, based on communication between control pods 28B, 28Y and control computer 24. The communications medium between downhole and the surface may be wired drill pipe, fiber optics along the drill pipe or tubing, and the like.

For purposes of the description of embodiments of this invention, FIG. 2 illustrates kill line 33K and choke line 33C at blowout preventer 18. Kill line 33K is a high-pressure pipe connected between an outlet at blowout preventer 18 and rig pumps at drilling rig 16. Choke line 33C is a high-pressure pipe connected between an outlet at blowout preventer 18 and a backpressure choke and associated manifold (not shown). Choke line 33C and kill line 33K exit the subsea blowout preventer 18, and run along the outside of riser 15 to the surface.

During well control operations, upon actuating the appropriate rams of blowout preventer 18, kill fluid is pumped through the drillstring into the wellbore, circulating back to wellhead 12 via the annulus, and out of the well through choke line 33C to the backpressure choke, which is controlled to reduce the fluid pressure to atmospheric. In those cases in which circulation through the drill string is not possible, drilling mud is pumped from the surface into kill line 33K (and also possibly via choke line 33C in redundant fashion); this approach is known in the art as “bullheading”. In the event in which riser 15 is severed from the top of blowout preventer 18, it is known to control the well by severing one or both of kill line 33K and choke line 33C from riser 15, and connect these lines 33K, 33C, via a jumper line, to a source of drilling mud at the surface, or to a downhole collection and disposal manifold, or to an alternative source or destination for the fluid. With this connection, heavy drilling mud can be routed through the jumpers into either or both of choke line 33K and kill line 33C into the well via blowout preventer 18, to regain control of the well.

### General Construction and Operation of the Sensor Communication System

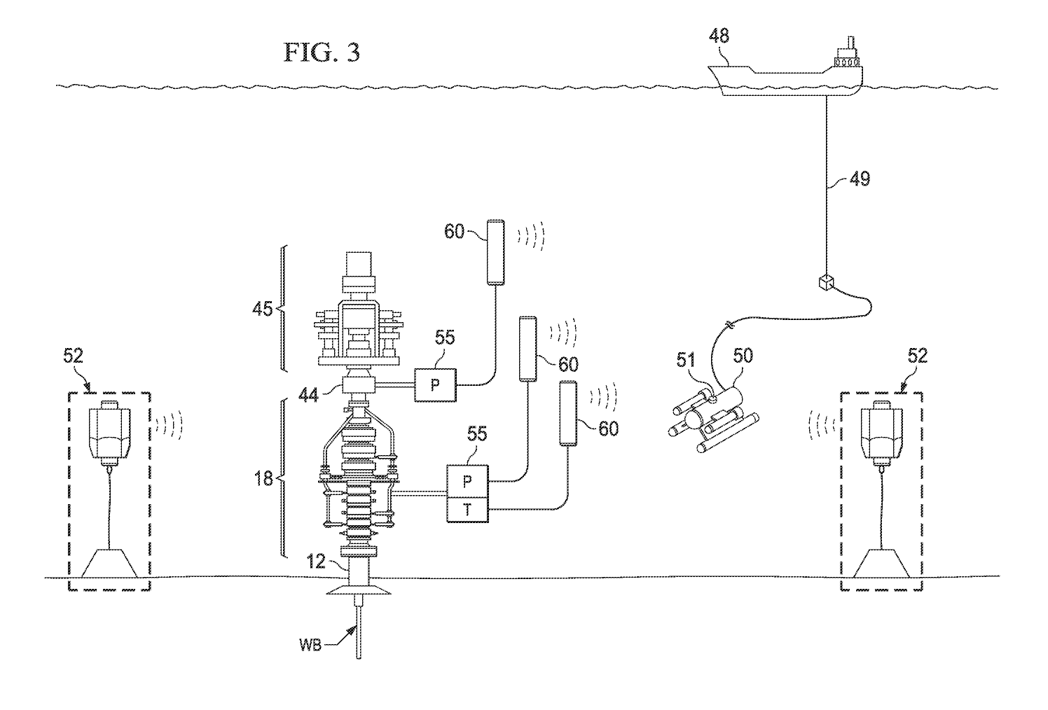

FIG. 3 illustrates a subsea situation in which an event has severed riser 15 and drill string 10 from blowout preventer 18, and in which additional equipment has been installed to gain control of the well. In the example of FIG. 3, capping stack 45 is placed upon and connected to lower marine riser package 44 at the top of blowout preventer 18. Capping stack 45 includes one or more sealing elements, such as blind or shear rams similar to those in blowout preventer 18 itself. Also in this example, some operations in the installation of capping stack 45, as well as control and monitoring of the operation of capping stack 45 and blowout preventer 18 are carried out by way of remotely-operated vehicle (ROV) 50. In the conventional manner, ROV 50 itself is navigated and controlled from ship 48 at the surface, via umbilical 49. In order to navigate ROV 50, knowledge of the location of ROV 50 relative to the subsea equipment of blowout preventer 18 and capping stack 45 is of course required. In the conventional manner, acoustic communications are carried out between an acoustic transceiver 51 deployed on ROV 50, and multiple fixed acoustic transponders 52 anchored to the seafloor as shown. For example, the acoustic transceiver implemented on ROV 50, according to embodiments of the invention, may be a conventional configurable, tri-band acoustic transceiver such as the COMPATT 5 transceiver available from Sonardyne, Inc. Conventional electronic functionality is provided within ROV 50 to demodulate and decode the received acoustic signals, and to transmit signals corresponding to those received signals via cabling within umbilical 49 to ship 48, at which computer functionality is deployed to analyze the signals received by ROV 50, and of course to control its navigation. As discussed above in connection with the Background of the Invention, the round-trip travel times of an acoustic interrogation signal from ROV 50 to each of multiple transponders 52 plus the acoustic response signals from those transponders 52 and ROV 50, can be applied to a triangulation or trilateralization technique to resolve the current three-dimensional position of ROV 50.

In a situation such as that illustrated in FIG. 3, surface personnel must understand the status of the well. As known in the art, parameters of particular importance include pressures and temperatures in the wellbore, and at equipment such as blowout preventer 18 including its LMRP 44, and capping stack 45 in FIG. 3. For example, if kill line 33K and choke line 33C have been re-routed to conduct kill fluid or drilling mud, pressures and temperatures sensed at kill line 33K and choke line 33C will be indicative of well pressure and temperature, and will thus provide important knowledge regarding the extent to which the well is being controlled. However, because riser 15 and the associated tubing have been severed from blowout preventer 18, the usual communications medium between pressure and temperature sensors at blowout preventer 18 and monitoring systems at the surface is lost. Even if those downhole pressure and temperature sensors are operable, their readings cannot be monitored with any sort of regularity, much less in the real-time manner that is expected in responding to such an event.

In the generalized arrangement of FIG. 3, according to embodiments of this invention, communications capability is provided to communicate subsea pressure and temperature sensors, obtained at sealing elements and conduits of blowout preventer 18 and (if installed and operable) capping stack 45, to surface personnel for monitoring, analysis, and decisions regarding additional control efforts. As shown in FIG. 3, one or more sensors 55 are deployed at blowout preventer 18 and at capping stack 45 (e.g., at connector 44 between capping stack 45 and blowout preventer 18). Each deployment of sensors 55 includes one or more sensors in fluid communication with the wellbore itself via blowout preventer 18 or capping stack 45, as the case may be, or in fluid communication with fluids such as kill fluid or drilling mud being used to control the well. It is contemplated that sensors 55 will typically include one or more instances of either or both of pressure and temperature sensors, as it is contemplated that these measurements assist personnel charged with controlling the well in this situation. In this example, sensors 55 at blowout preventer 18 include the combination of a pressure sensor and a temperature sensor. Sensors 55 can include sensors for other attributes and parameters, as desired. In embodiments of this invention, each sensor 55 generates an electrical signal as an output, indicative of the sensed physical parameter.

According to embodiments of this invention, the measurements obtained by sensors 55 are communicated to the surface via ROV 50. As such, the output signal from each sensor 55 is electrically coupled to a corresponding acoustic transponder 60. In the example of FIG. 3, each of dual sensors 55 at blowout preventer 18 is coupled to its own acoustic transponder 60, as shown. Acoustic transponders 60 are conventional computerized acoustic telemetry transponders (“compatts”), such as the COMPATT 5 and COMPATT 6 transponders available from Sonardyne, Inc. Each transponder 60 receives an output electrical signal from its associated sensor 55, and upon interrogation by an acoustic signal received from an acoustic communications device, transmits an acoustic signal encoded with data representative of the pressure, temperature, or other parameter sensed by sensor 55. This acoustic communications device will be capable of compatible acoustic communication with the particular model transponder deployed as transponders 60. In the example of FIG. 3, such an acoustic communications device is realized in the conventional manner for ROV navigation by acoustic transceiver 51 mounted at ROV 50, in combination with transceiver electronics (not shown) within a separate housing at ROV 50. Multiple ROVs 50 may be in the vicinity of the well, each gathering measurement data from the various sensors 55 via transponders 60, as will be described below.

Underwater acoustic communications between ROV 50 and transponders 52 for purposes of ROV navigation can be tone-based, with each transponder 52 issuing a response signal at an assigned frequency with no modulation. However, underwater communication of actual measurement data necessitates a more complex protocol than a simple tone at a given frequency. In embodiments of this invention, each transponder 60 transmits an acoustic signal that is modulated with the measurement data from its sensor 55. In a subsea environment in which acoustic transceiver 51 at ROV 50 (including, as described below, each of multiple ROVs 50 in the vicinity) is acoustically receiving measurement data from each of multiple transponders 60 for each of multiple associated sensors 55, data-bearing communications from each transponder 60 must be communicated in a dedicated channel to avoid interference. According to embodiments of this invention, such communication of measurement data by transponders 60 to acoustic transceivers 51 at corresponding ROVs 50 can be accomplished via wideband acoustic transmission as now supported by modern acoustic transponders, such as the COMPATT 5 and COMPATT 6 transponders available from Sonardyne, Inc., for example. Also as described above, acoustic transceiver 51 at ROV 50 may be the same acoustic transducer that, in combination with its transceiver electronics, is used in the navigation of ROV 50. Alternatively, a dedicated acoustic transducer or transceiver electronics, or both, may be used, if desired.

According to embodiments of the invention following the Sonardyne approach, each transponder 60 is assigned a dedicated transponder address code, to be used in generating a response to an interrogation signal received at a particular interrogation frequency. In this wideband implementation, the interrogation signals may also be wideband signals, with ROVs 50 controlled from different surface vessels having different assigned interrogation address codes relative to one another; typically, the interrogation carrier frequency differs from the response carrier frequency.

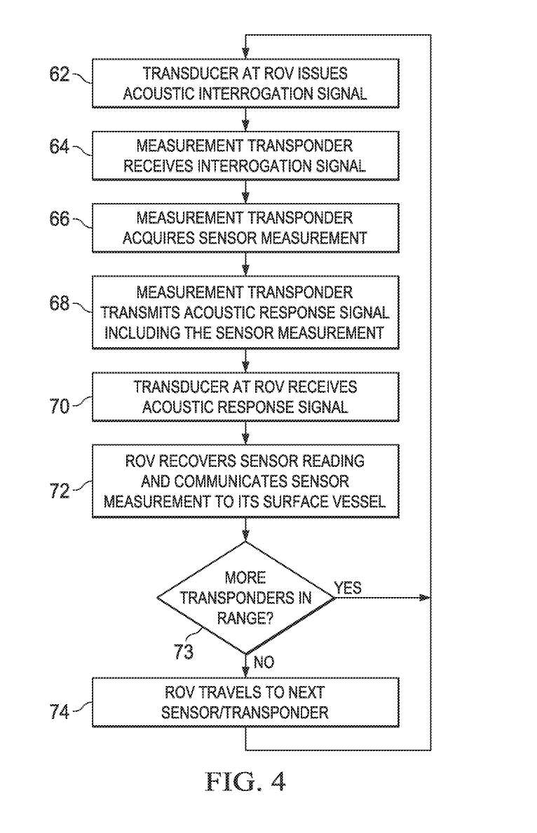

FIG. 4 illustrates a generalized interrogation procedure by way of which measurements by sensors 55 are communicated to ship 48 according to embodiments of the invention. It is contemplated that variations and alternatives to this method of communications will be apparent to those skilled in the art having reference to this specification.

The operation of this procedure begins with process 62, in which acoustic transceiver 51 at ROV 50 issues an acoustic interrogation signal to a selected one of transponders 60, to initiate acquisition of measurement data from its associated sensor 55. As mentioned above, in the wideband acoustic context, this interrogation signal may be a wideband signal at a preselected acoustic carrier frequency, encoded according to the address code associated with ROV 50, and possibly including an interrogation message addressed specifically to the selected one of transponders 60 from which a response is desired. In process 64, transponder 60 receives this interrogation signal, and recognizes it as such. In response to the received interrogation signal, transponder 60 acquires one or more quanta of measurement data from its sensor 55 for transmission to the acoustic transceiver 51. It is contemplated that the communication of measurement readings from sensor 55 to transponder 60 can be carried out in various ways. According to a simple approach, transponder 60 has an electrical input at which it continuously receives, directly from sensor 55, an analog signal representative of the measurement at the present time; in this case, acquisition process 66 is performed by transponder 60 simply by sampling the analog level at its sensor input. Alternatively, depending on the capability of transponder 60, acquisition process 66 may involve retrieving one or more previously sampled measurement readings (with or without some filtering applied) from its internal memory.

In any case, in process 68, transponder 60 transmits an acoustic response signal including the measurements acquired in process 66. According to the example described above, this transmitted response signal is in the form of a modulated acoustic carrier signal at a preselected carrier frequency, with the modulations including the measurement data encoded according to the transponder address code assigned to that particular transponder 60, distinguishing it from other transponders 60 in the vicinity. In process 70, that acoustic response signal is received by the acoustic transceiver 51 at ROV 50 that issued the interrogation signal in process 62; in process 72, the transceiver electronics at ROV 50 operate to recover the measurement data from the modulated response signal, and communicate that measurement data in the appropriate manner to ship 48 via umbilical 49. Typically, more than one transponder 60 is within range of ROV 50 in its current position, such that the interrogation and response sequence repeats in sequence. If a next transponder 60 to be interrogated is not currently within the acoustic range of ROV 50 (decision 73 is “no”), surface ship 48 then navigates ROV 50 to a position within acoustic range of that next transponder 60 in process 74, in order to interrogate and receive a measurement from its associated sensor 55. In either that case, or if that next transponder 60 to be interrogated is in range (decision 73 is “yes”), the data acquisition and storage process of FIG. 4 then repeats.

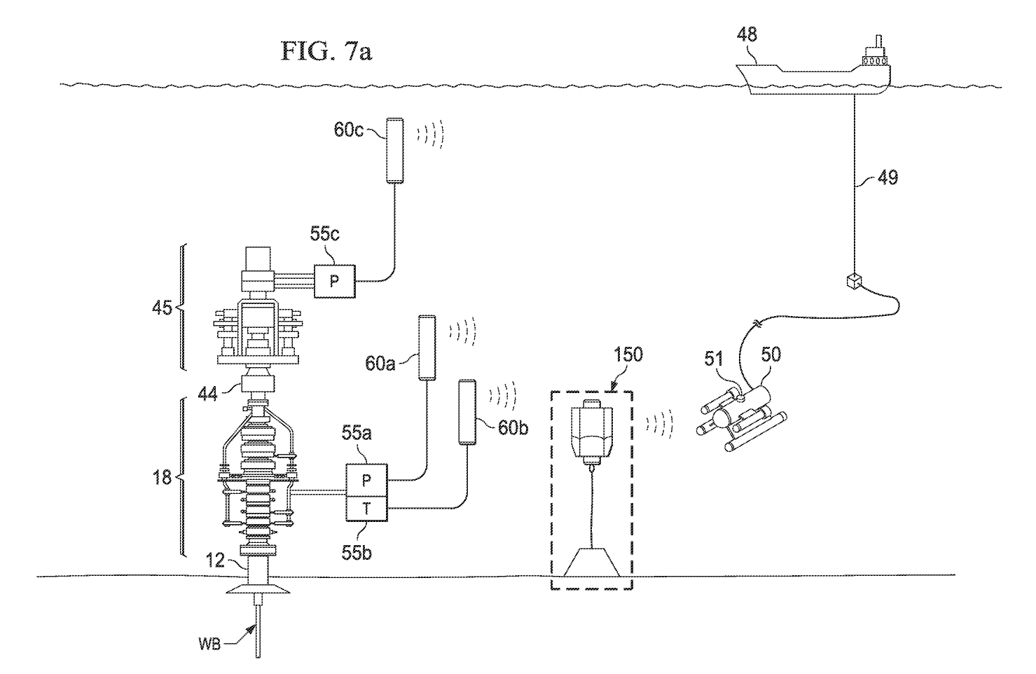

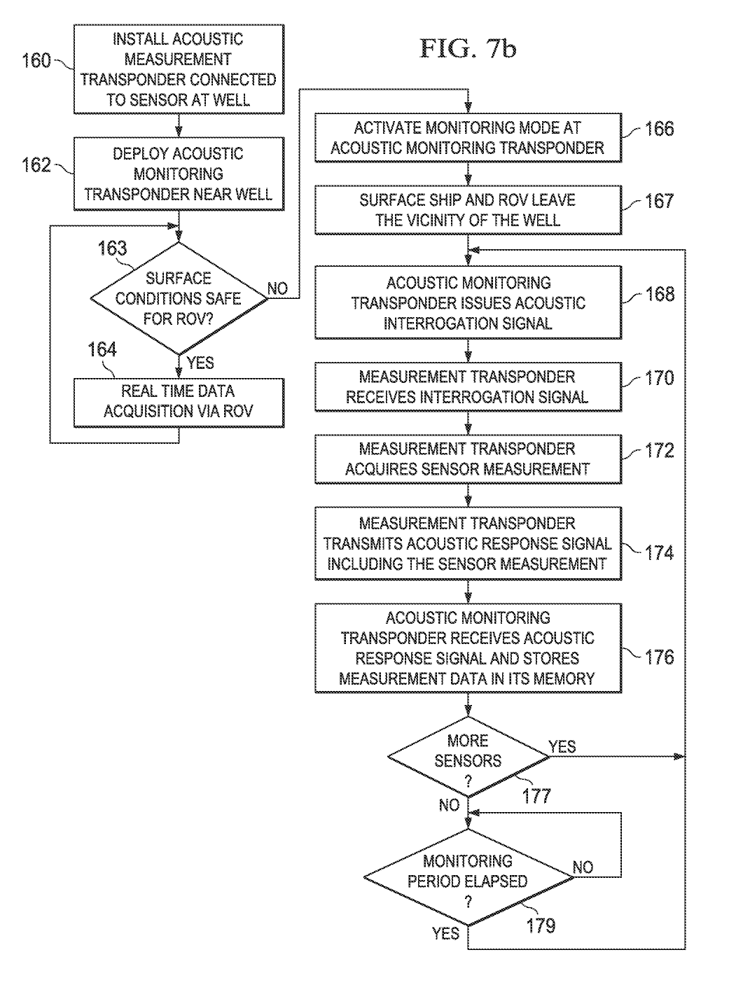

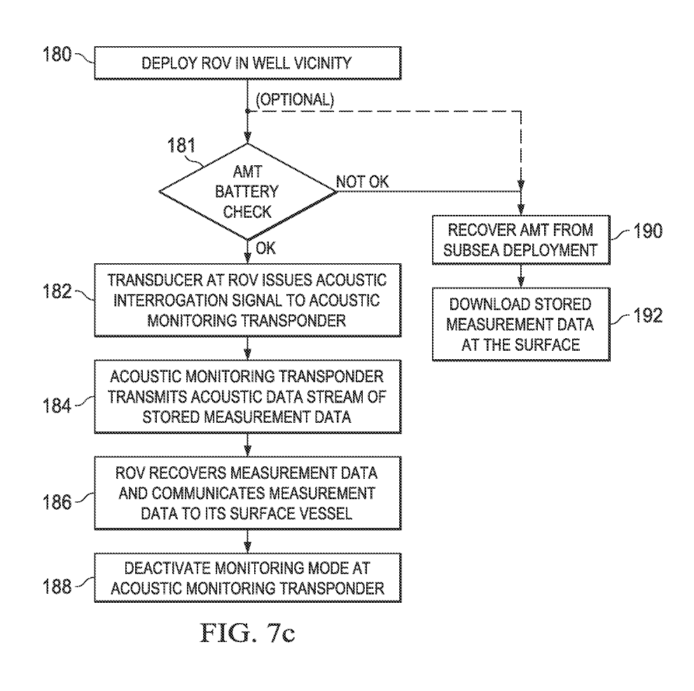

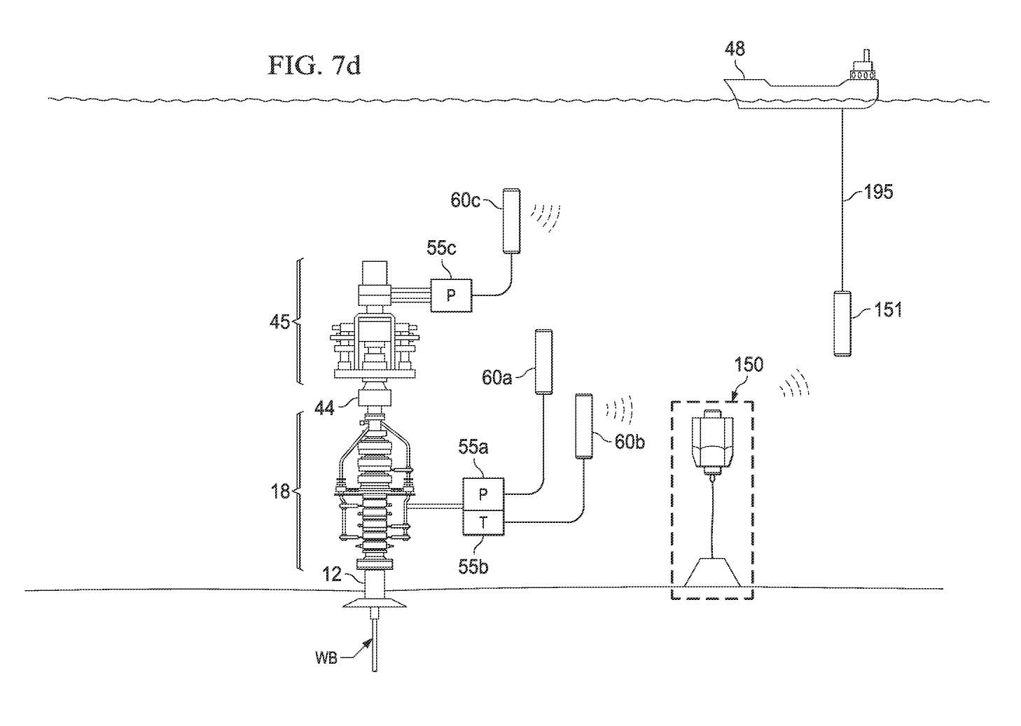

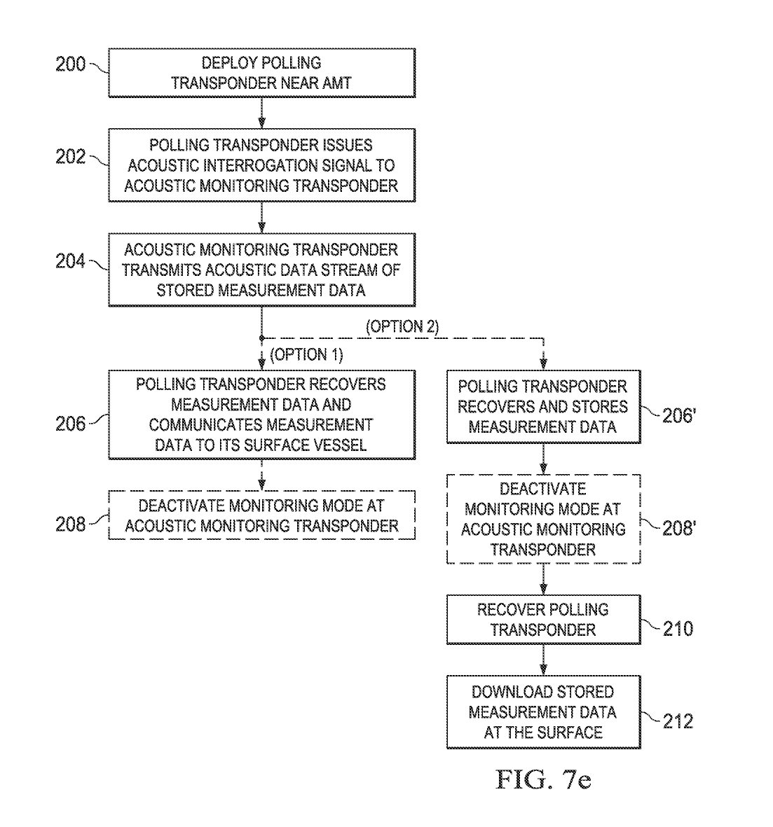

Alternatively, measurement data can be acquired from transponders 60 without the use of ROV 50. For example, a wideband acoustic transponder such as the COMPATT 6 transponder, serving as the acoustic communications device, may be suspended directly from ship 48 by way of an umbilical including the appropriate wired communications facility, as shown in 151 of FIG. 7d, discussed below. Transponders such as the COMPATT 6 transponder are contemplated to have sufficient acoustic range to carry out acoustic communication with one or more transponders 60 when deployed in that manner. In this alternative implementation, the suspended acoustic transponder will serve as the acoustic communications device by interrogating one or more transponders 60 by way of an address-bearing wideband interrogation signal, and receiving an encoded acoustic response signal from the addressed transponder 60 containing the measurement data in the manner described above for ROV-based data acquisition. The suspended acoustic transponder may communicate the measurement data to ship 48 during acquisition, for example by way of a wired communications facility in the umbilical. Alternatively, such a suspended polling acoustic transponder may store the measurement data it receives from transponders 60, for download to a computer system at ship 48 or elsewhere at the surface, after retrieval of the suspended transponder to the surface.

According to embodiments of this invention, the monitoring of important parameters such as pressure and temperature at a well following a blowout event can be obtained in a relatively frequent and real-time manner, despite loss of the normal communication medium between the well and the surface due to the blowout. Typically, the frequency of consecutive measurement data points will depend on the number of transponders 60 in the polling sequence carried out by ROV 50 (or transponder suspended from ship 48, as mentioned above). These pressure and temperature measurements assist in attaining and maintaining control of the well in this event. The communications capability provided by embodiments of this invention can meet this need.

However, transponders 60 may not generally be deployed with blowout preventer 18 at the time of drilling, due to reliability considerations, although the invention includes such use. In addition, sensors that are originally implemented in blowout preventer 18 may not survive a blowout event, or may not be in position to sense the pressures and temperatures that are of particular importance for a well control strategy that becomes necessary in a specific situation. Of course, capping stack 45 will certainly not be in place during drilling, and will only be implemented after the event. As such, post-blowout installation of sensors 55 and associated transponders 60 is contemplated to be necessary. Embodiments of this invention are directed to the construction and post-blowout installation of sensors 55 and transponders 60, as will now be described.

### Flanged Sensor

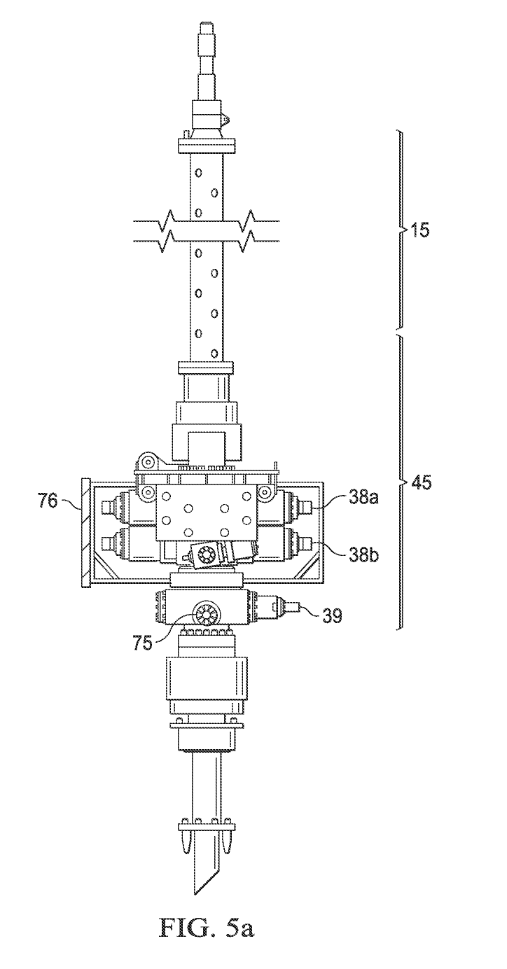

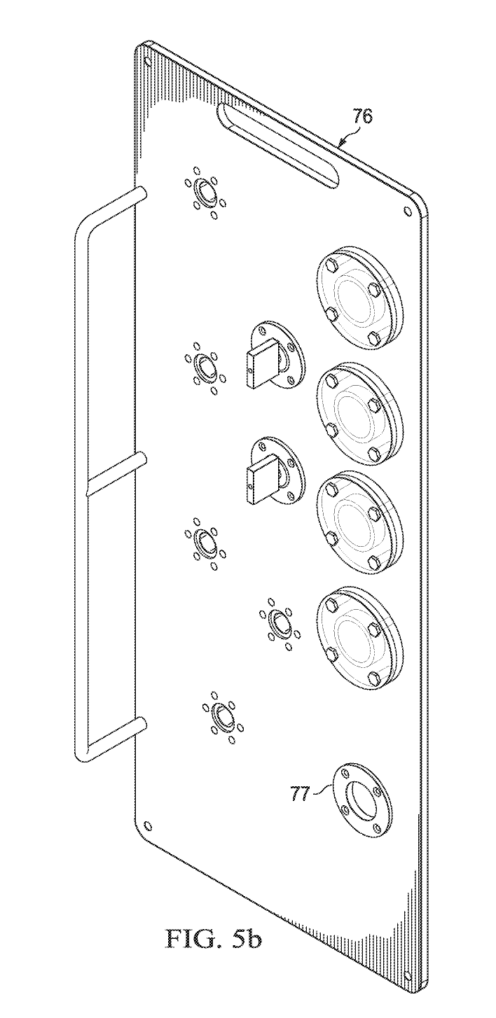

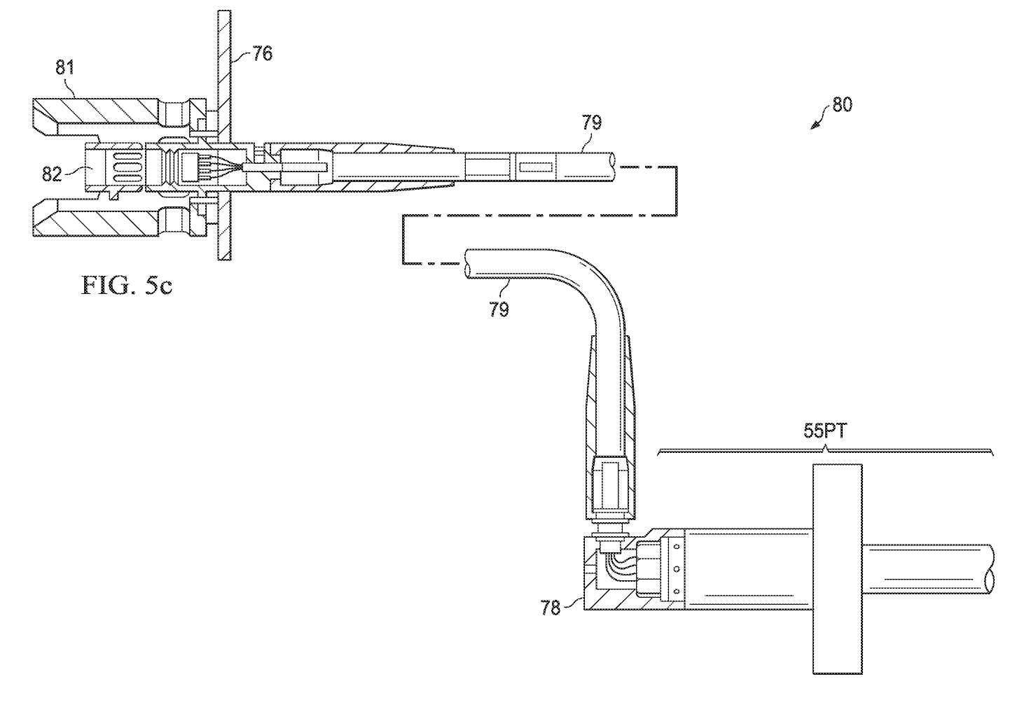

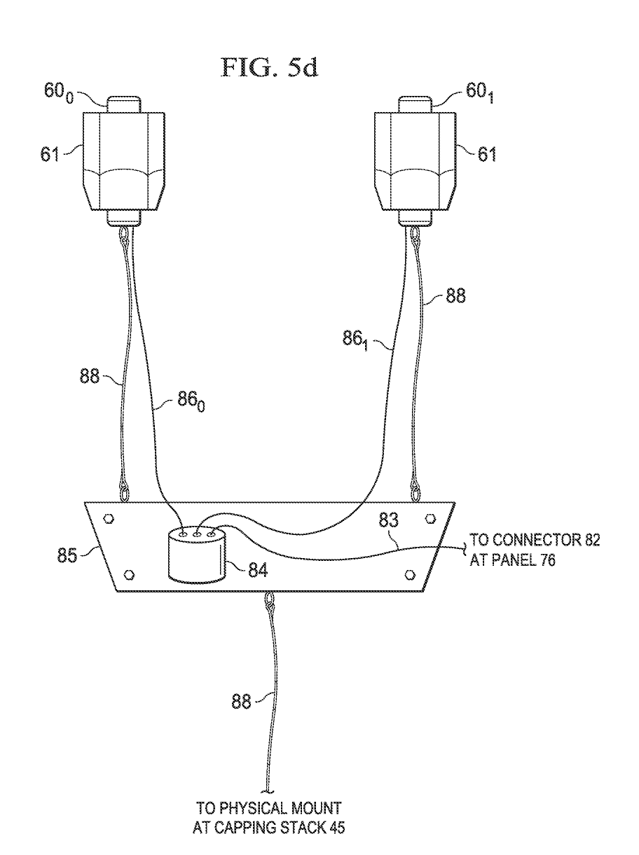

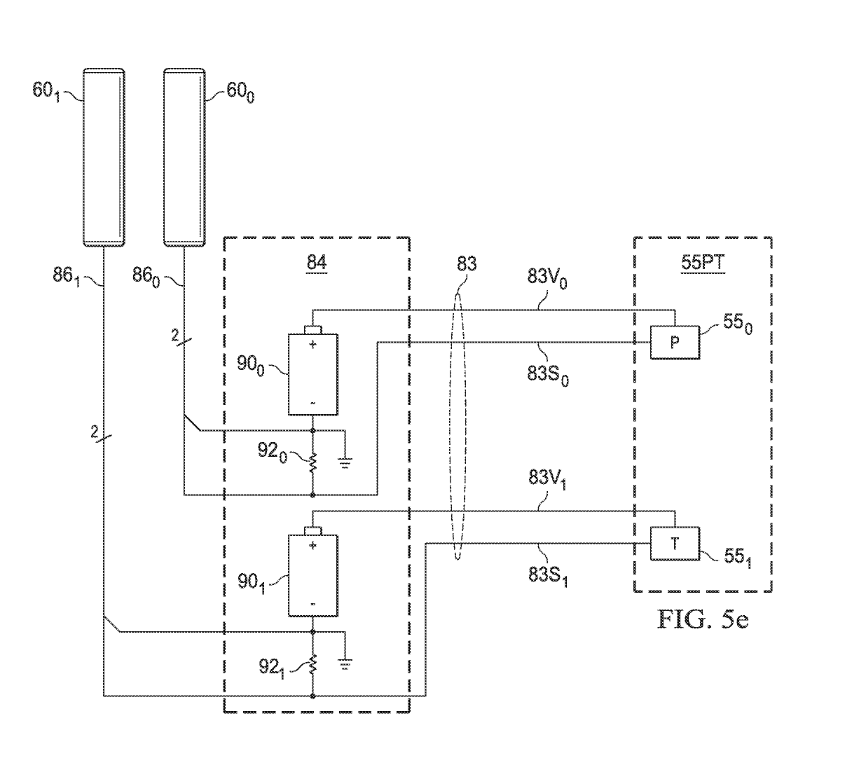

Referring now to FIGS. 5a through 5e, an embodiment of the invention in which either or both of pressure or temperature sensors 55 can be flanged into a sealing element assembly, such as blowout preventer 18 or capping stack 45, will be described. The availability of such a flanged sensor installation depends on the construction of its destination at blowout preventer 18 or capping stack 45, particularly the presence of a flange in the assembly at a location that is relevant to the well control operation. The description of this embodiment of the invention will refer to installation at capping stack 45 by way of example, it being understood that installation at blowout preventer 18 will be effected in a similar manner.

FIG. 5a is an elevation view of an example of capping stack 45, as connected to riser 15. In this example, capping stack 45 includes upper and lower blind shear rams 38a, 38b, respectively, and single test ram 39. In this example, flange 75 is present at test ram 39, and provides a location that is in fluid communication with the wellbore below test ram 39, and at which pressure, temperature, and other parameters that may be measured will be relevant to the control of the well following a blowout event. In an example of the implementation of this embodiment of the invention, one or more sensors 55 will be installed post-blowout at this flange 75, for acoustic communication of measurements to the surface in the manner described above in connection with FIG. 4.

FIG. 5a also illustrates the location of instrumentation and control panel 76 (along the left-hand side of capping stack 45 in that view), that will be utilized in connection with this embodiment of the invention. For example, panel 76 may correspond to either the choke panel or kill panel at capping stack 45, by way of which an ROV 50 can open or close various valves at rams 38a, 38b to carry out the desired choke or kill operation. FIG. 5b provides a perspective view of this panel 76, in which various valves and hydraulic connections are visible. In this example, opening 77 is a location in panel 76 at which may be installed a wet mate connector to sensors 55 mounted at flange 75, as will be described below.

FIG. 5c illustrates, in cross-section, sensor assembly 80 used in connection with this embodiment of the invention. Sensor assembly 80 includes pressure/temperature sensor 55PT. An example of pressure/temperature sensor 55PT useful in connection with this embodiment of the invention is a Cormon 11 kpsi dual-pressure and single-temperature transmitter, with a 4-20 mA output, available from Teledyne Cormon Limited. Sensor 55PT is installed into location 75 (FIG. 5a) of capping stack 45 in the conventional manner, utilizing an adapter flange as necessary for mounting at that location; that adapter flange and the mounting of sensor 55PT thereto, should be assembled and pressure tested prior to use. Electrical connection to sensor 55PT, including both power and signal lines, is made via connection shell 78, at which twisted pair wires within conduit hose 79 may be connected in the conventional manner. Conduit hose 79 runs from flange location 75 (FIG. 5a) at which sensor 55PT is mounted around to panel 76 on the side of capping stack 45. Conduit hose 79 connects to and terminates at wet mate connector 82 that is mounted at opening 77 of panel 76, and enables electrical connection to sensor 55PT via conduit hose 79. An example of a wet mate connector 82 suitable for use in connection with this embodiment of the invention is one of the NAUTILUS wet-mateable electrical connectors available from Teledyne ODI (Ocean Design, Inc.). Alignment funnel guide 81 surrounds connector 82, to assist the ROV in making electrical connection to connector 82.

FIG. 5d illustrates the physical arrangement of the communications transmitter function associated with sensor 55PT. Electrical conduit 83 extends from battery can 84 mounted to panel 85, as shown in FIG. 5d, to make connection to wet mate connector 82 at panel 76 (FIG. 5c). Panel 85 is a support panel formed of the appropriate steel or aluminum material, and is physically attached or mounted to capping stack 45 at an appropriate location by tether 88 and a corresponding connecting hook, or alternatively by bolts or another mechanical attachment. Panel 85 is physically attached to one or more acoustic transponders 60₀, 60₁ by way of corresponding tethers 88. In this example, because sensor 55PT provides both pressure and temperature measurements, respective acoustic transponders 60₀, 60₁ can separately communicate the pressure and temperature measurements obtained by sensor 55PT, over separate acoustic communications channels (which, accordingly, may be individually interrogated by acoustic transceiver 51 on ROV 50). Alternatively, the communicated measurements may correspond to other measurements, for example two separate pressure measurements in this example in which sensor 55PT is a dual-pressure/single-temperature sensor. As suggested by FIG. 5d, each of acoustic transponders 60₀, 60₁ are disposed within floatation collar 61, such that transponders 60₀, 60₁ will be suspended above panel 85 to the extent permitted by tethers 88. Electrical connection between battery can 84 and acoustic transponders 60₀, 60ₖ, is made by electrical conduits 86₀, 86ₖ, respectively.

FIG. 5e illustrates the electrical arrangement of sensor 55PT and its associated acoustic transponders 60₀, 60ₖ. In the schematic of FIG. 5e, sensor 55PT includes separate pressure sensor 55₀ and temperature sensor 55₁, each of which output a current within a given range (e.g., 4 to 20 mA) corresponding to the sensed parameter. Battery can 84 includes separate batteries 90₀, 90₁ for powering sensors 55₀, 55₁, respectively, and resistors 92₀, 92₁ for converting the sensor current from its respective sensor 55₀, 55₁ to a voltage for communication to acoustic transponders 60₀, 60ₖ. Electrical conduit 83 from battery can 84 includes power lines 83V₀, 83V₁, which connect the anode of each battery 90₀, 90₁ to its respective sensor 55₀, 55₁. Conduit 83 also includes pressure signal line 83S₀, which carries the current output from sensor 55₀, and temperature signal line 83S₁, which carries the current output from sensor 55. Pressure signal line 83S₀ is connected to the cathode of battery 90₀ (at ground) via resistor 92₀, and temperature signal line 83S₁ is connected to the cathode of battery 90₁ (at ground) via resistor 92₁, in each case completing the circuit. In this example, transmitters 55₀, 55₁ each function as variable current sources, with the output current dependent on the measured pressure and temperature, respectively.

Resistors 92₀, 92₁, in this example, are nominal 250 Ω resistors, for converting the sensor output current range of 4 to 20 mA to the acoustic transponder input voltage range of 1 to 5 volts, maximizing the resolution of the communicated results. As such, conduit 86₀ includes two wires connected across resistor 92₀ within battery can 84, communicating the voltage drop across resistor 92₀ to transponder 86₀; conduit 86₁ similarly includes two wires connected across resistor 92₁ in battery can 84, communicating the voltage drop across resistor 92₁ to transponder 60ₖ. Transponders 60₀, 60₁ each include their own battery, and thus do not require power from battery can 84. Considering that transponders 60₀, 60₁ sense input voltage, these devices present very high input impedance to the sensor circuits.

Because absolute temperature and pressure readings from blowout preventer 18 or capping stack 45, as the case may be, are desirable in the attaining and maintaining of well control, it is of course important to precisely know the resistances of each of resistors 92₀, 92₁. It has been observed, in connection with this invention, that the specified precision of conventional precision resistors is not necessarily adequate for this purpose. According to this embodiment of the invention, post-installation calibration of these resistors can be carried out based on the calibration data of the sensors obtained at the time of manufacture. According to this approach, for the example of pressure sensor 55₀, independent knowledge of the ambient pressure can be obtained, for example by obtaining a measurement from ROV 50 or by calculation. A pressure measurement from sensor 55₀ is then obtained under those same ambient conditions, by way of interrogation by ROV 50 in the manner described above. The signal received from associated acoustic transponder 60₀ will correspond to the voltage across resistor 92₀ for that measurement. Using the manufacturer calibration data to estimate the current at the known ambient pressure, the communicated voltage communicated by transponder 60₀ can be divided by that estimated current to precisely determine the resistance value of resistor 92₀. Once that precise resistance value is determined, the measured voltages communicated by transponder 60₀ can be divided by that resistance value to obtain the output current from sensor 55₀, and thus an accurate measurement of pressure, upon scaling the measured output current within its full output current range (e.g., between 4 mA to 20 mA), which corresponds to the minimum and maximum pressures indicated by the calibration data at those full current range endpoints. It has been observed, in practice, that this calibration approach provides good accuracy in the measurements obtained from sensors 55₀, 55₁, and thus provides a way to calibrate these important measurements post-installation.

This embodiment of the invention thus enables installation and operation of the necessary equipment and resources after a blowout event to communicate relatively frequent and real-time measurements of important parameters, such as pressure, temperature, and the like, based upon which well control actions can be determined and evaluated.

### Hot Stab Sensor

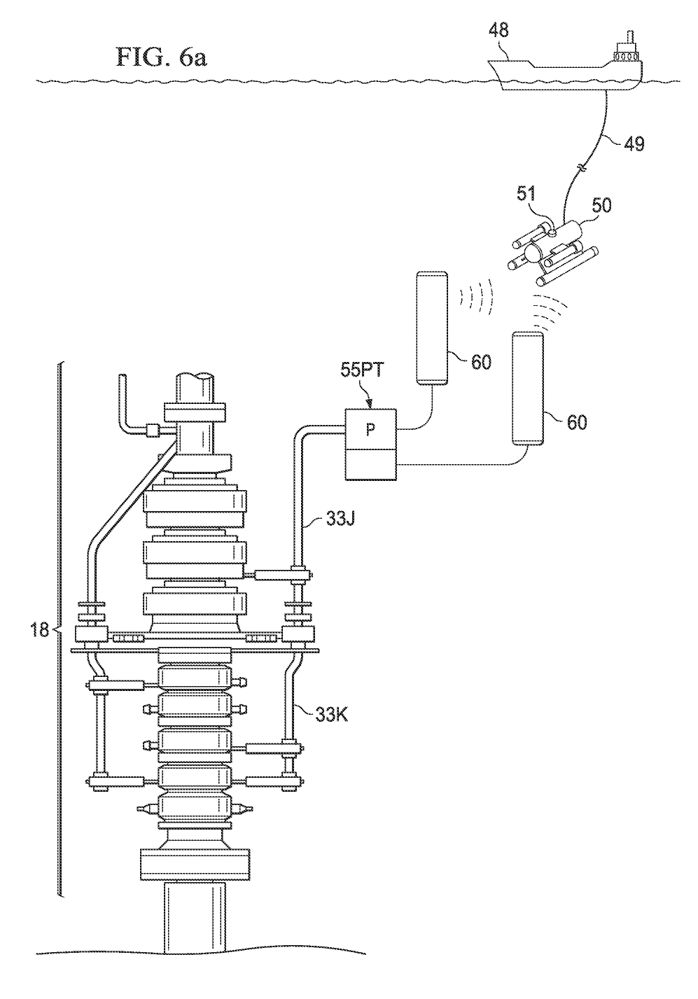

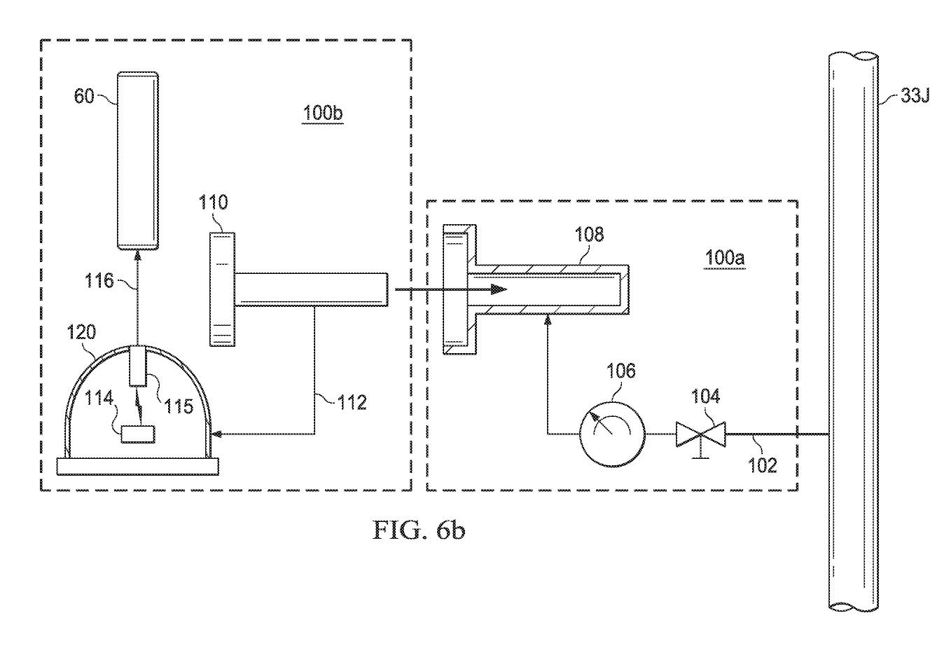

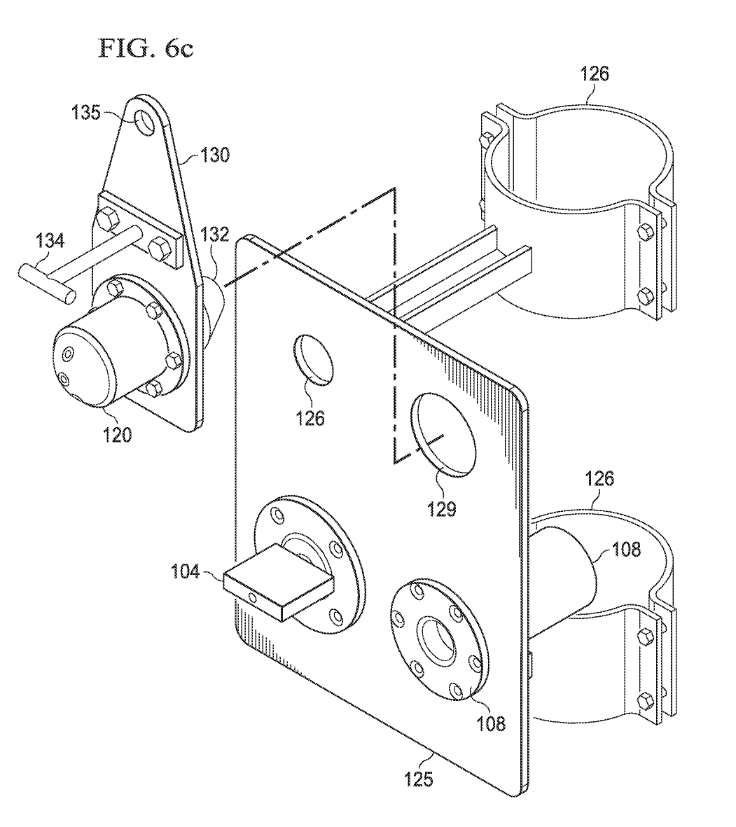

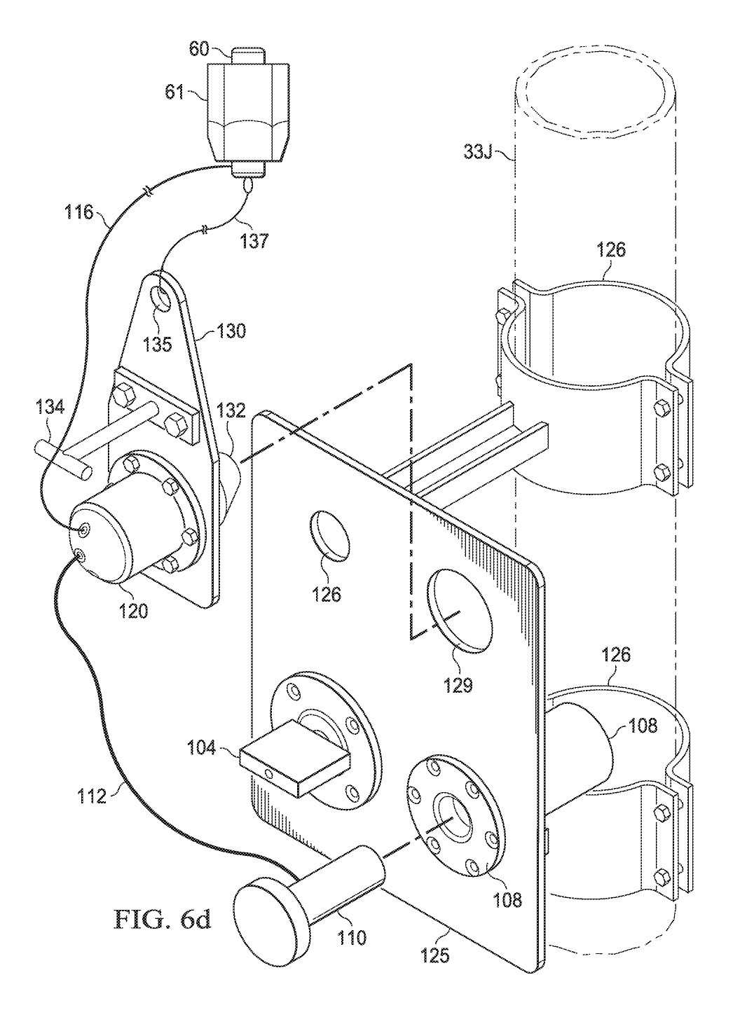

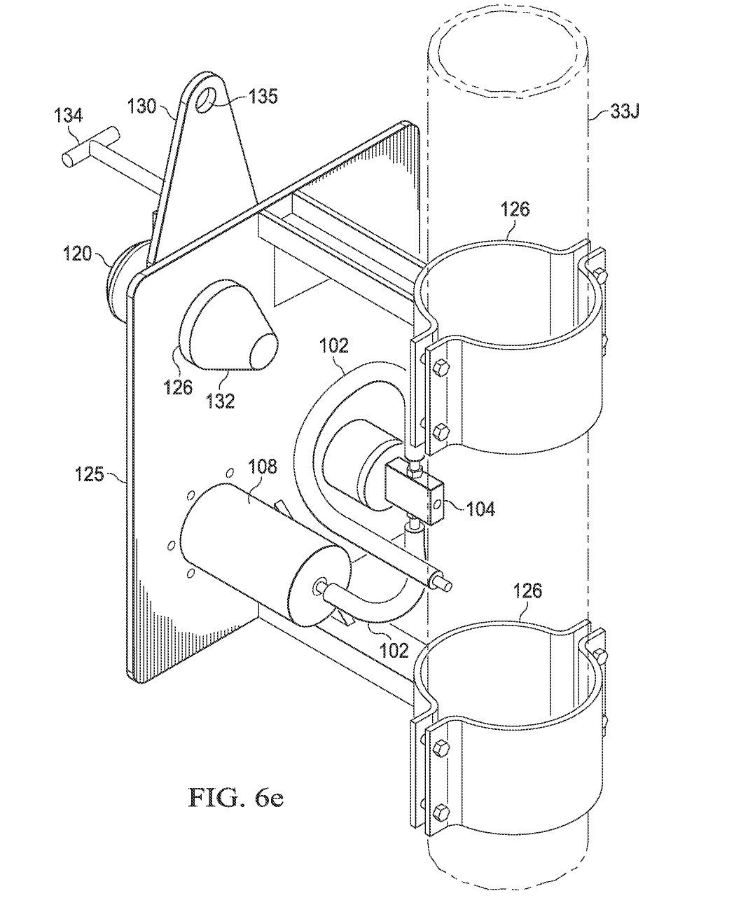

According to another embodiment of the invention, as will now be described in connection with FIGS. 6a through 6e, one or more sensors 55 are installed post-blowout into a jumper line or other conduit, by way of a hot stab arrangement. As discussed above, one or both of choke line 33C and kill line 33K may be re-routed by way of a jumper conduit to conduct kill fluid from the well annulus in a well control operation, or to conduct drilling mud from the surface to control the well, or for some other function involved in controlling the well. In each of those instances, parameters regarding the contents of the jumper conduit or other piping at the sealing element assembly (e.g., blowout preventer 18, capping stack 45) may be of interest to well control operations. This embodiment of the invention enables the installation and operation of a communications system by way of which frequent and real-time measurements from those sensors are communicated to the surface, despite the absence of a fixed communications medium such as a wired facility along the drill string or production tubing.

FIG. 6a illustrates this arrangement in a generalized form. As shown in that Figure, kill line 33K of blowout preventer 18 has been severed from riser 15, and re-routed via jumper conduit 33J to a source of drilling mud at the surface, or to a downhole collection and disposal manifold, or to some other source or destination of the fluid conducted via jumper conduit 33J and kill line 33K, depending on the particular well control operation. In any case, parameters such as pressure and temperature at the interior of jumper conduit 33J are of interest to the well control operations. According to this embodiment of the invention, sensors 55PT are connected to be in fluid communication with jumper conduit 33J on one side, and in electrical connection with acoustic transponder 60. As described above, acoustic transponder 60 communicates acoustic signals encoded with data corresponding to the pressure or temperature measurements acquired by sensors 55PT, upon receipt of an interrogation signal from an acoustic communications device, such as acoustic transceiver 51 mounted on ROV 50 in combination with its transceiver electronics, as described above. In that example, acoustic transceiver 51 receives the encoded response signal from acoustic transponder 60, and its associated transceiver electronics then communicate data corresponding to the acquired measurements via umbilical 49 to computing and monitoring systems at ship 48.

FIG. 6b shows a hydraulic and electrical schematic of the sensor and communications system according to this embodiment of the invention. As will be apparent to those skilled in the art, the connection of kill line 33K or choke line 33C to some other source or destination in response to a blowout event requires the installation of the appropriate jumper conduit and other equipment, in connection with the well control procedure. According to this embodiment of the invention, a portion of the sensor and communications system is installed initially with this jumpering onshore, prior to deployment of the combination of jumper conduit 33J; sensors 55PT and acoustic transponder 60 are subsequently installed by way of an ROV at the appropriate time.

In this embodiment of the invention, system portion 100a is installed onto jumper conduit 33J prior to deployment. System portion 100a includes instrumentation tubing 102, which is in fluid communication with the vessel or tubing to be monitored, which in this case is jumper conduit 33J. Paddle valve 104 is in-line with instrumentation tubing, with dial gauge 106 optionally plumbed into instrumentation tubing 102 beyond paddle valve 104. Instrumentation tubing 102 terminates at hot stab receptacle 108, which is mounted to an appropriate gauge panel 125, which is shown in FIG. 6c as will now be described. Gauge panel 125 includes clamps 126 that clamp to jumper conduit 33J, securely mounting panel 125 and its associated components to the subsea equipment. FIG. 6c also illustrates paddle valve 104 and hot stab receptacle 108 at gauge panel 125; instrumentation tubing 102 is not shown, for purposes of clarity. Window 126 provides ROV visibility of dial gauge 106, which may be installed, if desired, behind panel 125 (i.e., on the same side of panel 125 as clamps 126).

Referring back to FIG. 6b, system portion 100b is installed subsea, after deployment of jumper conduit 33J and system portion 100a, as described above. According to this embodiment of the invention, system portion 100b includes hot stab connector 110, which is constructed to mate with hot stab receptacle 108. Conduit 112 is in hydraulic communication with hot stab connector 110, and hydraulically connects hot stab connector 110 to housing 120, within which sensor 115 and battery 114 (serving as the power source for sensor 115) are housed. Electrical conduit 116 electrically connects sensor 115 with acoustic transponder 60. If level (or current-to-voltage) conversion is required to calibrate the output range of sensor 115 to the input range of acoustic transponder 60, the appropriate components will be implemented within housing 120, as described above.

FIG. 6c illustrates floatation attachment 130, to which housing 120 (and thus sensor 115 and its battery 114) is mounted. Floatation attachment 130 is a small panel to which housing 120 is mounted opposite lead cone 132; ROV handle 134 is mounted to the housing side of floatation attachment 130. Lead cone 132 facilitates mounting of floatation attachment 130 by an ROV in the subsea environment, by way of the insertion of lead cone 132 into opening 129 of panel 125.

FIGS. 6d and 6e schematically illustrate the fluid and electrical connection among the various components of system portions 100a, 100b. As shown in FIGS. 6d and 6e, clamps 126 affix panel 125 to jumper conduit 33J. As shown in FIG. 6e, hydraulic conduit 102 is plumbed to jumper conduit 33J behind panel 125, and is routed through paddle valve 104 to hot stab receptacle, for this example in which dial gauge 106 is not present. Referring back to FIG. 6d, hot stab connector 110 is connected via hydraulic conduit 112 to a receptacle at housing 120 (FIG. 6e). Upon insertion of hot stab connector 110 into hot stab receptacle 108, housing 120 will be in fluid communication with hydraulic conduit 102, as mentioned above.

As shown in FIG. 6d, acoustic transponder 60 is deployed within floatation collar 61, and is physically attached to opening 135 of floatation attachment 130 by way of tether 137. Electrical conduit 116 is connected between a receptacle at housing 120, and acoustic transponder 60; conduit 116 is somewhat longer than tether 137, to avoid the tension from floatation collar 61. As shown in FIG. 6e, lead cone 132 is insertable into opening 126 of panel 125, but is smaller than opening 126. The upward force exerted by floatation collar 61 and tether 137 will pull lead cone 132 upward, locking it into opening 126 and thus securing floatation attachment 130 to panel 125.

The communication of measurements obtained by sensor 115 (within housing 120) according to this embodiment of the invention is similar to that described above for the flanged installation. Accordingly, upon insertion and mating of hot stab connector 110 into and with hot stab receptacle 108, the interior of housing 120 is in fluid communication with jumper conduit 33J, via hydraulic conduit 102, 112, and paddle valve 104. Sensor 115 is thus able to sense the particular parameter (e.g., pressure) of that fluid, and thus the fluid of jumper conduit 33J as desired. It is contemplated that this hot stab sensor installation will generally be better suited for sensing and communicating pressures rather than temperatures. Sensor 115 issues an electrical signal (e.g., a voltage within a specified range) to acoustic transponder 60 corresponding to the sensed pressure, temperature, or other parameter. Upon receipt of an acoustic interrogation signal from an acoustic communications device, such as acoustic transceiver 51 on ROV 50, as described above, acoustic transponder 60 transmits an acoustic signal encoded with data corresponding to the measurement obtained by sensor 115. In that example, acoustic transceiver 51 and its associated transceiver electronics at ROV 50 then communicate data corresponding to this and other measurements acquired from other sensors, to surface personnel via umbilical 49 and ship 48, in the manner described above.

According to this embodiment of the invention, post-blowout installation and operation of the necessary equipment and resources to monitor and frequently communicate real-time measurements of important parameters relevant to well control operations can be carried out.

### Network Redundancy

In the event of blowout of an offshore oil and gas well, a large number of personnel may be involved in taking remedial action. Time may be of the essence in making decisions regarding well control actions to be taken, and the importance of those decisions requires evaluation of the best available subsea measurement data. Reliability in the acquisition and communication of those subsea measurement data at a relatively high frequency and continuously over time is therefore an important attribute of the overall measurement communication system.

As described in copending and commonly assigned application Attorney Docket No. 41000, entitled “Acoustic Telemetry of Subsea Measurements from an Offshore Well”, filed contemporaneously herewith and incorporated herein by reference, a high level of communications network redundancy can be implemented in connection with the acoustic telemetry of measurements at blowout preventer 18 and capping stack 45. This redundancy includes the use of multiple ROVs 50 in the vicinity of blowout preventer 18 and capping stack 45, each interrogating each acoustic transponder 60 and receiving measurement data in response. These multiple ROVs 50 are supported from multiple associated surface ships 48, each of which has its own computer network on board, by way of which measurement data acquired from subsea sensors at blowout preventer 18 and capping stack 45 can be monitored and analyzed as desired. In addition, according to the redundancy implemented in this embodiment of the invention, each ship 48 includes multiple communication facilities for communicating those data and local analysis. Those communications facilities include satellite communications capability and also wireless radio communications capability. For example, wireless radio communications may be used for communications within a “local” area network made up of the computer networks among ships 48 that are at sea and in the vicinity of the well. Satellite communications may be used in connection with that “local” area network as well and also for communication with one or more data centers located on shore, or around the world as the case may be.

In any event, according to embodiments of this invention, substantial redundancy is provided in the communications network involved in obtaining and integrating measurement data from subsea sensors at the well following a blowout event, without requiring the riser, drill string, or other physical conduit to be in place. As such, if an issue arises regarding any one of the radio or satellite communications links, multiple alternative data paths in the overall network are provided according to embodiments of this invention, whether among the ships at the well site, or among onshore facilities such as data centers, or both. This redundancy also does not rely on a single data acquisition and processing protocol, thus enabling multiple vendors to be involved at the well. The overall robustness of the system is therefore improved.

### Acoustic Monitoring Transponder

The communication of measurement data from sensors 55 and acoustic transponders 60 via ROVs 50 to surface personnel requires deployment of ROVs 50 and their supporting surface ships 48 in the vicinity of the well. As is well known in the industry, however, surface conditions at sea are not always conducive to the deployment of ships 48 and ROVs 50, especially in storm-vulnerable locations such as the Gulf of Mexico. In particular, tropical storms and hurricanes require evacuation of surface vessels from sea-going locations in the path of those storms. According to the systems described above, which rely on ROVs and the like to communicate measurement data from the seafloor to the surface, such evacuation breaks the communications links between the subsea sensors and the personnel monitoring and managing the well. Especially in events such as blowouts and the remediation of those blowouts, the need for relatively continuous and real-time measurements of conditions at the well continues, however.

According to embodiments of the invention, capability for acquiring measurement data from subsea equipment at the well, for example at blowout preventer 18 and capping stack 45 in the situation of FIG. 3 in which communications media to the surface are otherwise lost or severed, is provided. Time-dependent parameters such as pressures, temperatures, and the like are acquired, stored, and retrieved as surface conditions permit, according to embodiments of this invention as will now be described in connection with FIGS. 7a through 7c.

FIG. 7a illustrates a subsea situation similar to that described above in connection with FIG. 3, using the same reference numerals as used in that Figure for the same components. As described above, FIG. 7a illustrates the situation in which riser 15 and drill string 10 are severed from or otherwise compromised relative to blowout preventer 18, and in which capping stack 45 is placed upon and connected to lower marine riser package 44 at the top of blowout preventer 18, as described above relative to FIG. 3. As described above, one or more sensors 55 are deployed at the subsea equipment, including in this example both blowout preventer 18 and capping stack 45. In this example, pressure sensor 55a and temperature sensor 55b are deployed at blowout preventer 18. Each sensor 55a, 55b is connected to a corresponding acoustic transponder 60a, 60b, respectively, for example as described above in connection with FIGS. 5a through 5e. Similarly, pressure sensor 55c is deployed at capping stack 45 according to one of the embodiments of the invention described above, and is connected to acoustic transponder 60c. As before, acoustic transponders 60 are conventional computerized acoustic telemetry transponders (“compatts”), such as the COMPATT 5 and COMPATT 6 transponders available from Sonardyne, Inc. The floating collars that lend buoyancy to acoustic transponders 60 are not shown in FIG. 7a, for the sake of clarity. Of course, more or fewer sensors 55 may be deployed at the subsea equipment, depending on the attributes and parameters that are desired to be sensed.

In the situation of FIG. 7a according to this embodiment of the invention, acoustic monitoring transponder 150 is deployed at a subsea location in the vicinity of the well. In the example shown in FIG. 7a, acoustic monitoring transponder 150 is not itself mounted to the subsea equipment of blowout preventer 18 and capping stack 45, but rather is deployed at the seafloor, for example by way of a weighted anchor in the typical manner for the deployment of navigation transponders (e.g., as described above relative to FIG. 3, in connection with navigation transponders 52). Alternatively, acoustic monitoring transponders 150 may be mounted to the subsea equipment. In any case, acoustic monitoring transponder 150 is deployed to a location that is within acoustic range of those acoustic transponders 60 with which it is to communicate, as will be described in detail below.

According to this embodiment of the invention, acoustic monitoring transponders 150 may be implemented by way of a conventional acoustic monitoring transponder 150 having data logging capability, and capable of wideband or other high data rate acoustic communications capability for transmitting and receiving acoustic signals encoded with measurement data. An example of such a modern transponder suitable for use in connection with this embodiment of the invention is the COMPATT6 acoustic transponder available from Sonardyne, Inc. Other transponders that include these capabilities may alternatively be used.

In addition to the placement or mounting of acoustic monitoring transponders 150, as described above, the manner and timing of the deployment of acoustic monitoring transponders 150 may vary. It is contemplated, for example, that acoustic monitoring transponders 150 will generally not be deployed at the same time as acoustic transponders 60 and sensors 55 as the case may be. According to this approach, acoustic monitoring transponders 150 would be deployed only if necessary in advance of an approaching tropical storm or hurricane; acoustic communications via ROV 50 as described above would be the usual technique for communicating measurement data to the surface. Alternatively, of course, acoustic monitoring transponders 150 may be deployed in conjunction with the deployment of measurement acoustic transponders 60. Further in the alternative, acoustic monitoring transponders 150 may themselves be the same transponders as used for ROV navigation (i.e., may serve also as transponders 52 in the situation of FIG. 3), although it is contemplated that this approach, which is still within the scope of the invention, would involve using more capable (and expensive) equipment for the lesser task of navigation. It is contemplated that those skilled in the art having reference to this specification will be readily able to realize and implement acoustic monitoring transponders 150 in a suitable manner for a given situation.

According to embodiments of this invention, the measurements obtained by each sensor 55 are communicated to its corresponding acoustic transponder 60. Each transponder 60 receives an output electrical signal from its associated sensor 55, and upon receiving an acoustic interrogation signal, that transponder 60 transmits an acoustic signal encoded with data representative of the pressure, temperature, or other parameter sensed by sensor 55. In this embodiment of the invention, acoustic monitoring transponder 150, deployed in the vicinity of the well, issues the interrogation signal to transponders 60a through 60c, and stores measurement data encoded within the acoustic response signal transmitted by transponders 60a through 60c in response to that interrogation signal. Acoustic monitoring transponder 150 is operating in a “data logging” operational mode in this instance, and stores those measurement data in its internal memory resource. In this embodiment of the invention, it is contemplated that acoustic monitoring transponder 150 will be operating essentially in an autonomous fashion, periodically issuing acoustic interrogation signals to each of transponders 60a through 60c individually, and storing the measurement data in the corresponding response signals for later retrieval. ROV 50 is thus not involved in the acquisition and storing of measurement data at acoustic monitoring transponder 150, in this embodiment of the invention.

The view of FIG. 7a illustrates ROV 50 in the vicinity of the well, with ROV 50 including acoustic transceiver 51 and its associated transceiver electronics (not shown), in acoustic communication with acoustic monitoring transponder 150. In this position, acoustic transceiver 51 at ROV 50 can activate acoustic monitoring transponder 150 to begin periodic acquisition of measurement data from transponders 60, and to store those data. ROV 50 can then leave the vicinity of the well, for example in advance of storm conditions at the surface. Also in this position, after monitoring of sensors (via transponders 60) by acoustic monitoring transponder 150, acoustic transceiver 51 at ROV 50 can interrogate acoustic monitoring transponder 150 upon its return to the vicinity of the well, to retrieve that measurement data and to subsequently de-activate acoustic monitoring transponder 150 from acquiring further measurement data if desired. It is contemplated that these activation and interrogation/retrieval acoustic signals between acoustic transceiver 51 at ROV 50 and acoustic monitoring transponder 150 will be carried out by way of wideband acoustic signaling, in which control signals and the measurement data are encoded within the modulated acoustic signal, as described above.

Referring now to FIG. 7b, the operation of the arrangement of FIG. 7a incorporating acoustic monitoring transponders 150 according to embodiments of this invention will now be described. This operation begins with process 160, in which sensors 55 and transponders 60 are installed at the subsea equipment of blowout preventer 18, or capping stack 45, or both, as the case may be. This installation process 160 may correspond to the post blowout installation of transponders 60, and perhaps also sensors 55, according to the embodiments of the invention described above in connection with FIGS. 5a through 5e and 6a through 6e. In any case, process 160 provides the subsea equipment with the capability of sensing physical parameters regarding the well or the subsea equipment involved in controlling the well, and the capability of acoustically transmitting measurements of those parameters upon interrogation, as described above.

In process 162, one or more acoustic monitoring transponders 150 are deployed near the well. For clarity, this process of FIG. 7b will be described for the simple case in which a single acoustic monitoring transponder 150 is deployed. Of course, those skilled in the art will be readily able to adapt this operation to deploy and operate multiple acoustic monitoring transponders 150. As shown in FIG. 7a, acoustic monitoring transponder 150 may be deployed at the seafloor, using a weighted anchor arrangement similar to that typically used for navigation transponders. Alternatively, acoustic monitoring transponder 150 may be mounted directly on the blowout preventer 18 or capping stack 45 at a location within range of its associated measurement transponders 60. However, it is contemplated that acoustic monitoring transponder 150 will, for cost reasons, typically not be deployed until shortly before evacuation of the surface vicinity of the well in advance of an approaching storm, in which case deployment by way of the weighted anchor will generally be more efficient and cost effective, although the invention includes deployment at any time. Alternatively, in some cases, acoustic monitoring transponder 150 may be previously installed, for example shortly after the riser has been severed, or indeed even at the time of normal drilling activity. Further in the alternative, acoustic monitoring transponder 150 may in fact be one or more of the same physical transponders 52 as used for ROV navigation, in which case process 162 will be performed at the initiation of ROV navigation in the vicinity of the well. This process 162 may not necessarily activate the monitoring function of acoustic monitoring transponder 150, but instead merely deploys one or more transponders 150 at the desired locations.

Decision 163 determines whether conditions at the surface of the sea, overlying the well, remain safe for surface ships 48 and thus for the navigation of ROVs 50 supported by those ships 48. If so (decision 163 is “yes”), process 64 is performed to acquire and communicate measurement data from sensors 55 via transponders 60 and ROV 50, in the manner described above in connection with FIG. 4. However, if conditions become unsafe for ships 48 in the vicinity of the well (decision 163 is “no”), on its last trip to the subsea equipment at the well, the acoustic communications device at ROV 50, via its transceiver electronics and its acoustic transponder 51, executes process 166 by acoustically communicating the appropriate control signals to acoustic monitoring transponder 150 to direct it to acquire measurement data from those sensors 55 in its vicinity, via acoustic communications with those transponders 60 associated with those sensors 55. It is contemplated that the acoustic communications carried out in activation process 166 will correspond to the protocol defined for the particular model of acoustic monitoring transponder 150. In this regard, it is contemplated that activation process 166 may also communicate configuration information to acoustic monitoring transponders 150, such information including the selected acoustic communication channels to be used, the addresses of those transponders 60 with which each acoustic monitoring transponder 150 is to communicate, synchronization to a common time source (e.g., GPS time), an interrogation period (e.g., once every five minutes), and the like. In process 167, ROV 50 and its surface ship 48 then leave the vicinity, relying on acoustic monitoring transponder 150 to acquire and store the measurement data from sensors 55.

The acquisition and monitoring operation begins with process 168, in which acoustic monitoring transponder 150 transmits an acoustic interrogation signal to one of its associated transponders 60. This interrogation signal can be identical, as far as transponder 60 is concerned, to that issued by acoustic transceiver 51 at ROV 50 in the data acquisition process described above in connection with FIG. 4, and will typically include an encoded address indicating that a particular transponder 60 is being interrogated. In process 170, the intended transponder 60 receives that interrogation signal and recognizes that it is being interrogated, in response to which that transponder 60 transmits an acoustic signal encoded with a measurement then generated by its associated sensor 55, in process 174. In process 176, acoustic monitoring transponder 150 receives that acoustic signal from interrogated transponder 60, recovers the measurement data value encoded within that acoustic signal, and stores that measurement data value in its internal memory, associated with a time stamp or other indication of the time of that measurement.

If multiple transponders 60 are to be interrogated by acoustic monitoring transponder 150, processes 168 through 176 will then be repeated by acoustic monitoring transponder 150 and the remaining transponders 60 to be interrogated within a given interval. Specifically, in decision 177, acoustic monitoring transponder 150 determines whether additional sensors within its range are to be interrogated within this interrogation period. If so (decision 177 is “yes”), then an index indicating the particular sensor 55 and transponder 60 to be interrogated is incremented, and control returns to process 168 to interrogate and retrieve measurement data from that sensor 55 via its transponder 60.

As mentioned above, the measurement data acquisition and storage performed by acoustic monitoring transponder 150 in this embodiment of the invention is contemplated to be carried out periodically, according to configuration information communicated to it in process 166, or stored within acoustic monitoring transponder 150 prior to deployment. If no more sensors 55 are to be interrogated in this monitoring period (decision 177 is “no”), decision 179 is executed to determine whether the monitoring period has yet elapsed. If not (decision 179 is “no”), acoustic monitoring transponder 150 continues to wait until that period has elapsed, at which time (decision 179 is “yes”), control returns to process 168 in which acoustic monitoring transponder 150 next interrogates the first transponder 60 in its sequence to acquire its next measurement value. The process continues for each deployed acoustic monitoring transponder 150, interrogating each of its associated transponders 60, in the absence of ROV 50 or other surface-supported vehicles.

FIG. 7c illustrates an example of the operation of this system in retrieving the stored measurement data from acoustic monitoring transponder 150. This data retrieval will typically be performed as soon as practicable after the storm conditions at the surface, or other situation precluding the deployment of surface ships 48 and ROVs 50, has cleared. In process 180 of FIG. 7c, ROV 50 is deployed in the vicinity in the conventional manner, such as illustrated in FIG. 7a. Once ROV 50 is navigated to within the range of acoustic monitoring transponder 150, its acoustic communications device (i.e., acoustic transponder 151 and its associated transceiver electronics) performs a remote battery check of acoustic monitoring transponder 150 in the conventional manner, in decision 181. If sufficient battery power remains at acoustic monitoring transponder 150 (decision 181 is “yes”), then acoustic transponder 51 at ROV 50 transmits an acoustic interrogation signal to acoustic monitoring transponder 150 in process 182, requesting acoustic monitoring transponder 150 to acoustically communicate its stored contents for receipt at ROV 50. That transmission from acoustic monitoring transponder 150 is performed in process 184; the particular encoding and protocol by way of which these measurement data and associated time stamp information are transmitted will be defined by the particular model and operation of acoustic monitoring transponder 150, as known in the art. In process 186, acoustic transceiver 51 senses the acoustic signals from acoustic monitoring transponder 150, and transceiver electronics at ROV 50 recover the measurement data and time information from the encoded acoustic signals received following transmission process 184, and communicates those data via umbilical 49 to its surface ship 48. As mentioned above and as described in copending application Attorney Docket No. 41000 entitled “Acoustic Telemetry of Subsea Measurements from an Offshore Well”, the retrieved measurement data can then be communicated via the redundant radio and satellite networks with which computer systems at ship 48 are in communication.

It is contemplated, in this embodiment of the invention, that ROV 50 will acquire and communicate measurement data from sensors 55 and transponders 60 under calm surface conditions. In this case, process 188 is then performed by the acoustic transceiver 151 at ROV 50 transmitting an acoustic control signal to acoustic monitoring transponder 150 to de-activate its monitoring (i.e., interrogation and acquisition) operation. Acoustic monitoring transponder 150 then may be retrieved, if desired, or may simply remain idle awaiting the next event causing it to be activated.

An alternative data recovery process is also shown in FIG. 7c, by way of an optional path following deployment of ROV 150 in the vicinity of the well (process 180), or in the event that the battery check determines that acoustic monitoring transponder 150 lacks sufficient battery power (decision 181 is “not ok”). In this alternative data recovery approach, acoustic monitoring transponder 150 is physically retrieved by ROV 50 from its deployed position, in process 190, and brought to ship 48 at the surface. Once retrieved from its subsea deployment to the surface, acoustic monitoring transponder 150 is then powered up and connected to a computer system or server at ship 48, which downloads the stored measurement data from the retrieved acoustic monitoring transponder 150 for communication via the surface network, in process 192.

Referring now to FIGS. 7d and 7e, an alternative approach to retrieving the stored measurement data from acoustic monitoring transponder 150 according to this embodiment of this invention will now be described. As shown in the view of FIG. 7d, no ROV is deployed in the vicinity of acoustic monitoring transponder 150 to acquire the stored measurement data. Rather, the acoustic communications device in this instance corresponds to polling acoustic transponder 151, which is lowered from ship 48 into a position that is within acoustic range of acoustic monitoring transponder 150. Umbilical 195 is a physical tether of polling acoustic transponder 151 to ship 48; in addition, umbilical 195 may also provide a conduit for a wired communication facility between polling acoustic transponder 151 and a computer system or server at ship 48. It is contemplated that a modern wideband transponder, such as the COMPATT 6 acoustic transponder available from Sonardyne, serving as polling acoustic transponder 151 will have sufficient acoustic range to enable its deployment for this purpose, without requiring use of an ROV or other navigable vehicle to approach subsea acoustic monitoring transponder 150 and acquire the stored data. In this alternative implementation, polling acoustic transponder 151 can operate as a “repeater” of the transmitted measurement data.

The operation of the arrangement of FIG. 7d in acquiring the stored measurement data at acoustic monitoring transponder 150 will now be described with reference to FIG. 7e. In process 200, ship 48 in the vicinity of the well deploys polling acoustic transponder 151 to a location and depth that is within acoustic range of acoustic monitoring transponder 150, for example in the manner shown in FIG. 7d. Once in this position, polling acoustic transponder 151 transmits an acoustic interrogation signal to acoustic monitoring transponder 150, requesting acoustic monitoring transponder 150 to transmit an acoustic signal encoded with data corresponding to its stored contents, for receipt by polling acoustic transponder 151, which occurs in process 204.

According to this embodiment of the invention, two options are provided for communicating the acquired measurement data to the surface network. In one approach (option 1 of FIG. 7e), polling acoustic transponder 151 recovers the stored measurement data from the acoustic signal received from acoustic monitoring transponder 150, and while still deployed subsea, communicates those measurement data to a computer system or server aboard its surface ship 48 via a wired communications facility within umbilical 195, in process 206. Upon completion of the acquisition of measurement data from acoustic monitoring transponder 150, polling transponder 151 may simply be removed from the area, allowing acoustic monitoring transponder 150 to continue to acquire and store sensor measurements from sensor 55 and transponder 60, as described above relative to FIG. 7b. Optionally, if the acquisition of measurement data by acoustic monitoring transponder 151 is complete (e.g., if telemetry facilities are provided for the continuous communication of measurement data, such as described above relative to FIGS. 3 and 4), then polling acoustic transponder 151 deactivates the monitoring functionality at acoustic monitoring transponder 150, in process 208, by transmitting the corresponding acoustic deactivation signal.

According to another option (option 2 of FIG. 7e), polling acoustic transponder 151 is not in wired communication with the surface at this time. In this case, polling acoustic transponder 151 receives the acoustic signal from acoustic monitoring transponder 150, but stores that measurement data in its own memory, in process 206′. Optional process 208′ can then be performed to deactivate acoustic monitoring transponder 150, if deactivation is desired, as discussed above. In either case (deactivated or not), polling acoustic transponder 151 is physically recovered to the surface by ship 48, in process 210. Once retrieved, polling acoustic transponder 151 is electrically coupled to the onboard server or computer system at ship 48, and the recovered stored measurement data are then downloaded by the computer system or server at ship 48, for eventual communication to surface personnel via the redundant network mentioned above.

In either option, the stored measurement data acquired over time by acoustic monitoring transponder 150 are retrieved without requiring deployment of an ROV or other underwater vehicle. These approaches can, in some instances, reduce the cost of acquiring the measurement data, by enabling the use of lower-cost transponders rather than navigable ROVs and the like.

According to this embodiment of the invention, therefore, measurement of critical pressures, temperatures, and other parameters at the seafloor can be acquired even if storm and other inclement surface conditions preclude the use of ROVs and surface support ships. The subsea measurement data can be acquired at relatively high frequency (e.g., on the order of every few minutes) and stored locally, near the seafloor, for later retrieval. The local acquisition and storage by acoustic monitoring transponders, according to this embodiment of the invention, is essentially transparent to the measurement acoustic transponders, minimizing the pre-storm emergency deployment actions and thus facilitating rapid response.

According to embodiments of this invention, sensors can be installed subsea, for example after an event such as blowout of a well, and their measurements obtained and communicated without the presence of a riser, drill string, or production tubing supporting the communications medium. In particular, sensors and corresponding acoustic transceivers are installed at locations of a blowout preventer, capping stack, or other sealing element assembly, with the acoustic transceivers capable of acoustically communicating the measurement data upon interrogation by a remotely-operated vehicle in the vicinity of the well. According to an embodiment of the invention, if ROV operation becomes imprudent due to storms and hurricanes in the well vicinity, acoustic monitoring transponders can be deployed to acquire and store the measurement data for later retrieval. Upon receipt of the measurement data at a surface vessel, a redundant communications network is implemented by way of which data may be communicated among the vessels in the vicinity, and by satellite to onshore data centers, for monitoring and analysis. The continuous and real-time measurements acquired and analyzed in this manner facilitate the rapid and effective selection and evaluation of well control actions.

It is contemplated that embodiments of this invention can be utilized in alternative applications. For example, it is contemplated that this invention can be readily applied, by those skilled in the art having reference to this specification, to subsea structures for which a communications medium is not already in place. For example, the sensors may correspond to corrosion detectors, implemented into subsea structures (e.g. subsea pipelines) and their measurements acoustically communicated to ROVs, in the manner described herein.

While the present invention has been described according to its embodiments, it is of course contemplated that modifications of, and alternatives to, these embodiments, such modifications and alternatives obtaining the advantages and benefits of this invention, will be apparent to those of ordinary skill in the art having reference to this specification and its drawings. It is contemplated that such modifications and alternatives are within the scope of this invention as subsequently claimed herein.

What is claimed is:

1. A method of communicating measurements from subsea equipment, comprising the steps of:
sensing one or more physical parameters at the subsea equipment;
communicating an electrical signal corresponding to a first sensed physical parameter to a first acoustic transponder at the subsea equipment;
transmitting, from the first acoustic transponder, a coded acoustic signal including data corresponding to the first sensed physical parameter;
receiving the coded acoustic signal at an acoustic monitoring transponder deployed within acoustic range of the first acoustic transponder;
storing, in a memory in the acoustic monitoring transponder, measurement data corresponding to the first sensed physical parameter;
acquiring the stored measurement data from the acoustic monitoring transponder: and
communicating the acquired stored measurement data to a computing device, system, and/or network.

2. The method of claim 1, further comprising:
repeating the sensing, communicating, transmitting, receiving, and storing steps, prior to the acquiring step.

3. The method of claim 1, wherein the acquiring step comprises:
transmitting an interrogation signal to the acoustic monitoring transponder; and
responsive to the interrogation signal, transmitting a coded acoustic signal including the stored measurement data.

4. The method of claim 3, wherein the step of transmitting the interrogation signal is performed by an acoustic communications device deployed at an underwater vehicle;
and further comprising:
navigating the underwater vehicle to within acoustic range of the acoustic monitoring transponder;
receiving the coded acoustic signal including the stored measurement data at the acoustic communications device; and
communicating data corresponding to the stored measurement data from the acoustic communications device to the computing device, system, and/or network.

5. The method of claim 3, wherein the step of transmitting the interrogation signal is performed by an acoustic communications device suspended from a surface ship:
and further comprising:
receiving the coded acoustic signal including the stored measurement data at the acoustic communications device; and
communicating data corresponding to the stored measurement data from the acoustic communications device to the computing device, system, and/or network via a wired communications facility.

6. The method of claim 3, wherein the step of transmitting the interrogation signal is performed by an acoustic communications device suspended from a surface ship:
and further comprising:
receiving the coded acoustic signal including the stored measurement data at the acoustic communications device;
retrieving the acoustic communications device to the surface; and
then transferring the stored measurement data from the acoustic communications device to the computing device, system, and/or network.

7. The method of claim 1, wherein the acquiring step comprises:
retrieving the acoustic monitoring transponder to the surface; and
then downloading the stored measurement data from the acoustic monitoring transponder to a computer system in the computing device, system, and/or network.

8. The method of claim 1, further comprising:
transmitting an interrogation signal to the first acoustic transponder;
wherein the step of transmitting the coded acoustic signal from the first acoustic transponder is performed responsive to the first acoustic transponder receiving the interrogation signal.

9. The method of claim 8, wherein the step of transmitting an interrogation signal is performed periodically, according to a configuration setting of the acoustic monitoring transponder.

10. The method of claim 8, further comprising:
communicating an electrical signal corresponding to a second sensed physical parameter to a second acoustic transponder at the subsea equipment;
after the storing of measurement data corresponding to the first sensed physical parameter, then transmitting an interrogation signal to the second acoustic transponder;
responsive to the second acoustic transponder receiving the interrogation signal, transmitting, from the second acoustic transponder, a coded acoustic signal including data corresponding to the second sensed physical parameter;
receiving the coded acoustic signal of the second sensed physical parameter at the acoustic monitoring transponder;
storing, in a memory in the acoustic monitoring transponder, measurement data corresponding to the second sensed physical parameter in association with a time indicator;
repeating the sensing, communicating, operating, receiving, and storing steps.

11. The method of claim 10, further comprising:
communicating data corresponding to the stored measurement data to a surface location.

12. The method of claim 10, wherein the steps of transmitting an interrogation signal to the first and second acoustic transceivers are performed sequentially, and periodically according to a configuration setting of the acoustic monitoring transponder.

13. The method of claim 1, wherein the subsea equipment comprises a blowout preventer;
and wherein the first sensed physical parameter comprises a pressure at the blowout preventer.

14. The method of claim 13, wherein well tubing from the surface to the blowout preventer has been severed;
and wherein the first sensed physical parameter comprises a pressure in a choke line at the blowout preventer.

15. The method of claim 13, wherein well tubing from the surface to the blowout preventer has been severed;
and wherein the first sensed physical parameter comprises a pressure in a kill line at the blowout preventer.

16. The method of claim 1, wherein the subsea equipment comprises a capping stack mounted atop well tubing near the seafloor;
and wherein the first sensed physical parameter comprises a pressure at the capping stack.

17. The method of claim 4, further comprising:
transmitting an interrogation signal to the acoustic monitoring transponder via an acoustic communications device;
responsive to the acoustic monitoring transponder receiving the interrogation signal transmitting, via the acoustic monitoring transponder, a coded acoustic signal including the stored measurement data for receipt by the acoustic communications device; and
then transmitting, via an acoustic transceiver at the underwater vehicle, a deactivation signal to the acoustic monitoring transponder.

18. A sensor and transponder system for installation at a sealing element assembly deployed at an offshore hydrocarbon well, comprising:
a first sensor for sensing a physical parameter at a selected location of the sealing element assembly;
a first acoustic transponder in electrical communication with the first sensor, configured to transmit, in response to receiving an acoustic interrogation signal, coded acoustic signals including data corresponding to the physical parameter sensed by the first sensor; and
an acoustic monitoring transponder configured to periodically transmit an acoustic interrogation signal to the first acoustic transponder, and comprising a memory for storing measurement data corresponding to the data included within coded acoustic signals.

19. The system of claim 18, wherein the acoustic monitoring transponder is also configured to transmit, in response to receiving an acoustic interrogation signal, coded acoustic signals including the stored measurement data.

20. The system of claim 18, wherein the first sensor includes first and second transceivers for sensing first and second physical parameters.

21. The system of claim 18, further comprising:
a second sensor for sensing a physical parameter at a selected location of the sealing element assembly;
a second acoustic transponder electrically connected to the second sensor, adapted to transmit, in response to receiving an acoustic interrogation signal, coded acoustic signals including data corresponding to the physical parameter sensed by the second sensor;
wherein the acoustic monitoring transponder is configured to sequentially and periodically transmit an acoustic interrogation signal to the first and second acoustic transponder.

22. A method of communicating measurements from subsea equipment associated with a hydrocarbon well, comprising the steps of:
transmitting, subsea, a coded acoustic signal including data corresponding to measurements of one or more physical parameters at the subsea equipment;
receiving the coded acoustic signal at an acoustic monitoring transponder deployed subsea;
storing, in a memory in the acoustic monitoring transponder, data corresponding to the measurements;
repeating the obtaining, transmitting, receiving, and storing steps; and
acquiring the stored data from the acoustic monitoring transponder for communication to a computer network.

23. The method of claim 22, further comprising:
repeating the obtaining, transmitting, receiving, and storing steps, prior to the acquiring step.
